(19) United States
(12) Patent Application Publication
(10) Pub. No.: US 2018/0014212 A1
(43) Pub. Date: Jan. 11, 2018

(54) SATELLITE COMMUNICATION DEVICE, MANAGEMENT DEVICE, MONITORING SYSTEM, AND MONITORING METHOD

(71) Applicant: Mitsubishi Electric Corporation, Chiyoda-ku (JP)

(72) Inventors: Masao OGA, Tokyo (JP); Keijiro TAKE, Tokyo (JP)

(73) Assignee: Mitsubishi Electric Corporation, Chiyoda-ku (JP)

(21) Appl. No.: 15/547,648

(22) PCT Filed: Jun. 16, 2015
(86) PCT No.: PCT/JP2015/067347

§ 371 Date: Jul. 31, 2017

(51) Int. Cl. H04W 24/04; H04W 24/08; H04B 7/185

(52) U.S. Cl. CPC H04W 24/04; H04B 7/18515; H04W 24/08

(57) ABSTRACT

A satellite communication terminal according to the present invention includes a wired I/F unit to receive monitoring information from a mobile base station, which is a result of monitoring a device state of the mobile base station, a wireless I/F unit to perform radio communication with a satellite, a storage device to store therein monitoring-information processing policy information that indicates conditions for selecting the monitoring information to be transferred to the wireless I/F unit from among the monitoring information, and a monitoring-information processing unit to select the monitoring information to be transferred to the wireless I/F unit from among the monitoring information on a basis of the monitoring-information processing policy information, and to transfer the selected monitoring information to the wireless I/F unit.

### FIELD

The present invention relates to a satellite communication device, a management device, and a monitoring method in a monitoring system that monitors a ground radio communication system by using satellite communication.

### BACKGROUND

In recent years, increased attention has been focused on a communication means to accurately confirm the safety of individuals and transmit information if a major disaster has occurred, such as an earthquake or a tsunami. However, in a ground radio communication system for mobile phones and other devices which have become widespread among ordinarily users, communication facilities, that is, a communication infrastructure is monitored by mainly using a wired line such as a public telecommunication network. Therefore, there is a problem in that individual facilities cannot always be monitored accurately. For example, in the case of a break in a wired line due to the occurrence of a major disaster, a mobile base station connected to the wired line cannot be monitored. Further, if a concentrator, such as a relay device that concentrates mobile base stations, stops functioning due to a fault, a power outage, or other problems, then the mobile base stations connected to the concentrator cannot be monitored.

As a method for solving the problems as described above, Patent Literature 1 has disclosed a technique, in which a transmission-path control server collects base station information including an operational status from each base station by using satellite communication, identifies a base station that is adjacent to, and capable of communicating with, an isolated base station that is incapable of communicating with a base-station control device that is a higher-level device, and establishes a radio connection between the base stations as an emergency transmission path, in order to bring the isolated base station back into a state of being capable of communication. In the disclosed technique, even in the event of irregularities, it is still possible to continuously provide communication service.

### CITATION LIST

### Patent Literature

Japanese Patent Application Laid-open No. 2012-160933

### SUMMARY

### Technical Problem

However, the technique disclosed in Patent Literature 1 has a problem in that after the control server has identified an isolated base station that is incapable of communicating with the base-station control device by using satellite communication, if there is not an adjacent base station that is capable of communicating with the base-station control device, then the control server cannot continue or resume communication service. Further, in the technique disclosed in Patent Literature 1, in a state in which the satellite channel is busy due to the congestion caused by too many simultaneous access requests at the time of a disaster, there is a problem in that the control server may not efficiently collect information used for identifying an isolated base station, that is, it may be difficult to monitor the base stations.

The present invention has been achieved to solve the above problems, and an object of the present invention is to provide a communication device that can monitor a ground radio communication system by using satellite communication with high reliability, while minimizing heavy communication traffic and congestion of a satellite channel.

### Solution to Problem

In order to solve the problems and achieve the object, according to an aspect of the present invention, there is provided a satellite communication device including: a first communication unit to receive monitoring information from a communication device, which is a result of monitoring a device state of the communication device; a second communication unit to perform radio communication with a satellite; a storage device to store therein transfer information that indicates conditions for selecting the monitoring information to be transferred to the second communication unit from among the monitoring information; and a processing unit to select the monitoring information to be transferred to the second communication unit from among the monitoring information on a basis of the transfer information, and to transfer the selected monitoring information to the second communication unit.

### Advantageous Effects of Invention

The communication system according to the present invention has an effect where it is possible to monitor a ground radio communication system by using satellite communication with high reliability, while minimizing heavy communication traffic and congestion of a satellite channel.

### BRIEF DESCRIPTION OF DRAWINGS

FIG. 1 is a diagram illustrating a configuration example of a monitoring system according to the present invention, and a ground radio communication system that is a target to be monitored by the monitoring system.

FIG. 2 is a block diagram illustrating a configuration example of a mobile base station and a satellite communication terminal.

FIG. 3 is a block diagram illustrating a configuration example of a management device and a satellite base station.

FIG. 4 is a diagram illustrating a configuration example of a control circuit.

FIG. 5 is a sequence diagram illustrating an example of a processing procedure at the startup of the mobile base station and the satellite base station.

FIG. 6 is a block diagram illustrating an example of a data transfer path of the satellite communication terminal.

FIG. 7 is a diagram illustrating a configuration example of a monitoring-information processing policy information table saved in the satellite communication terminal.

FIG. 8 is a flowchart illustrating an example of a process of determining a monitoring-information processing policy in the satellite communication terminal.

FIG. 9 is a diagram illustrating a format of an SNAP packet.

FIG. 10 is a flowchart illustrating an example of a procedure of a device monitoring process in a device management unit of the mobile base station.

FIG. 11 is a diagram illustrating an example of a procedure of a monitoring-information setting process in a monitoring unit of the management device.

FIG. 12 is a diagram illustrating an example of device-state information stored in a storage device.

FIG. 13 is a sequence diagram illustrating an example of a procedure to obtain monitoring information in the management device.

FIG. 14 is a diagram illustrating an example of a transfer delay time when random transfer is performed.

FIG. 15 is a sequence diagram illustrating an example of a procedure to update the monitoring-information processing policy information stored in the satellite communication terminal.

FIG. 16 is a diagram illustrating a configuration example of an updated monitoring-information processing policy information table.

FIG. 17 is a sequence diagram illustrating an example of a monitoring-information collecting process in the management device when a disaster has occurred.

FIG. 18 is a diagram illustrating a device state of a mobile base station managed by the management device.

### DESCRIPTION OF EMBODIMENTS

A satellite communication device, a management device, a monitoring system, and a monitoring method according to an embodiment of the present invention will be described in detail below with reference to the accompanying drawings. The present invention is not limited to the embodiment.

### Embodiment

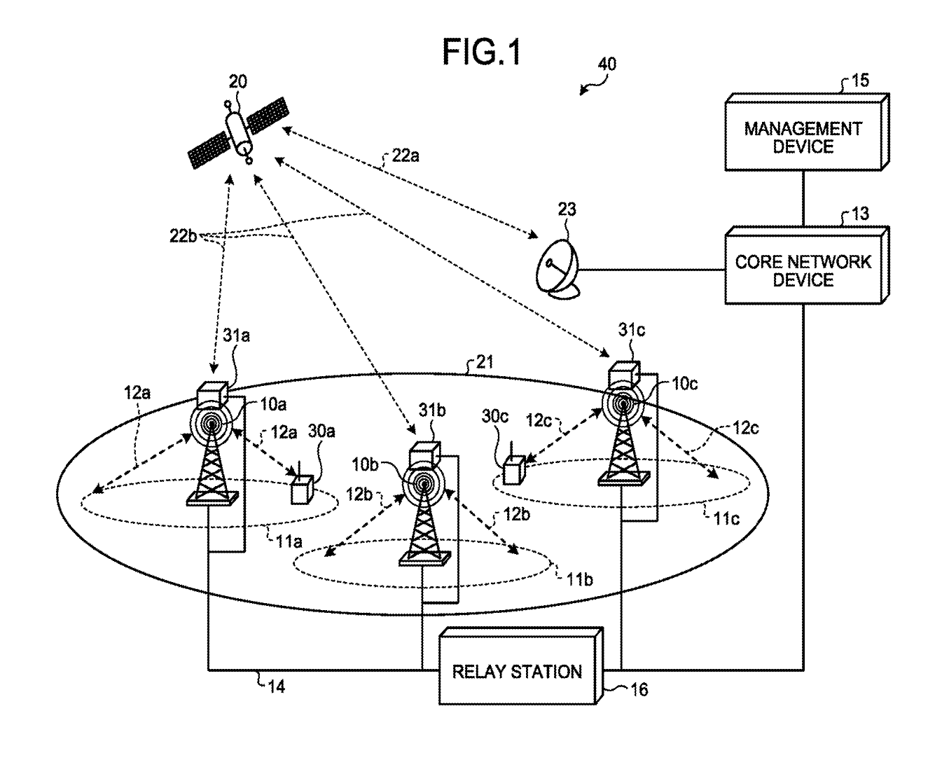

FIG. 1 is a diagram illustrating a configuration example of a monitoring system according to the present invention, and a ground radio communication system that is a target to be monitored by the monitoring system. In the present embodiment, as an example, the ground radio communication system that is a target to be monitored by the monitoring system according to the present embodiment is described as a mobile phone system that complies with communication standards for mobile phones such as LIE (Long Term Evolution) defined by 3GPP (3rd Generation Partnership Project) or the like. However, the ground radio communication system that is a target to be monitored by the monitoring system according to the present embodiment is not limited thereto. Further, an example is used, in which the satellite communication complies with the communication standards such GMR-1 3G (Geostationary Earth Orbit Mobile Radio interface-1 Third Generation) standardized by the ETSI (European Telecommunications Standards Institute). However, the communication standards for satellite communication are not limited thereto.

A monitoring system 40 according to the present embodiment includes a management device 15, satellite communication terminals 31a, 31b, and 31c, each of which is a satellite communication device according to the present invention, and a core network device 13. The ground radio system that is a target to be monitored by the monitoring system 40 according to the present embodiment includes mobile base stations 10a, 10b, and 10c, each of which is a communication device. That is, the mobile base stations 10a, 10b, and 10c constitute the ground radio system. It is possible that the ground radio system that is a target to be monitored by the management device 15 includes devices other than the mobile base stations 10a, 10b, and 10c, and also includes the core network device 13, a relay station 16, and other devices. However, in this example, monitoring of the mobile base stations 10a, 10b, and 10c is described below. The mobile base stations 10a, 10b, and 10c are connected to the core network device 13 and other mobile base stations 10a, 10b, and 10c through a wired line 14. The relay station 16 relays communication between the mobile base stations 10a and 10b, and the core network device 13 through the wired line 14. Further, the satellite communication terminal 31a is connected to the mobile base station 10a through the wired line 14, and is located at a position at a short distance from the mobile base station 10a. The position at a short distance indicates, for example, that the satellite communication terminal 31a is distanced from the mobile base station 10a by about several meters or less. It is also possible that the satellite communication terminal 31a and the mobile base station 10a are integrated into a single device. Similarly, the mobile base station 10c is connected to the satellite communication terminal 31c through the wired line 14. The satellite communication terminal 31c is located at a position at a short distance from the mobile base station 10c.

Service areas 11a, 11b, and 11c in FIG. 1 indicate the region where it is possible to communicate with the mobile base stations 10a, 10b, and 10c, respectively. That is, the service areas 11a, 11b, and 11c are areas where the mobile base stations 10a, 10b, and 10c are capable of providing mobile phone system service, respectively. The mobile base station 10a transmits and receives a mobile radio signal 12a to and from a mobile device 30a within the service area 11a. The mobile base station 10b transmits and receives a mobile radio signal 12b to and from a mobile device 30b within the service area 11b. The mobile base station 10c transmits and receives a radio signal 10c to and from a mobile device 36c within the service area 11c.

In the following descriptions, when the mobile base stations 10a, 10b, and 10c are described without being distinguished from each other, they are appropriately referred to as a “mobile base station 10”. Similarly, when the service areas 11a, 11b, and 11c are described without being distinguished from each other, they are appropriately referred to as a “service area 11”. When the mobile radio signals 12a, 12b, and 12c are described without being distinguished from each other, they are appropriately referred to as a “mobile radio signal 12”. When the mobile devices 30a and 30c are described without being distinguished from each other, they are appropriately referred to as a “mobile device 30”. When the satellite communication terminals 31a, 31b, and 31c are described without being distinguished from each other, they are appropriately referred to as a “satellite communication terminal 31”. While FIG. 1 illustrates three mobile base stations 10, the number of mobile base stations 10 is not limited thereto. It is sufficient that the number of mobile base stations 10 is equal to or greater than one. While FIG. 1 illustrates a single relay station 16, the number of relay stations 16 is not limited thereto. It is sufficient that the number of relay stations 16 is equal to or greater than one. FIG. 1 illustrates an example, in which there is a single mobile device 30a within the service area 11a, and ere is a single mobile device 30c within the service area 11c, while there is no mobile device within the service area 11b. However, the number of mobile devices within each service area 11 is not limited thereto.

The core network device 13 is a higher-level device that controls a plurality of mobile base stations 10, and executes a call control, an authentication process, and the like between the mobile base station 10 and the mobile device 30. The core network device 13 also has a function as a relay device that relays communication between the mobile base station 10 and the management device 15. The mobile base station 10 and the core network device 13 are connected through the wired line 14. Devices such as a router, the relay station 16, and an optical line, are connected to the wired line 14. The wired line 14, and the devices connected to the wired line 14, constitute the IF (Internet Protocol) network. An example is described below, in which communication through the wired line 14 uses the IP as a communication protocol. However, the communication protocol used in communication through the wired line 14 is not limited thereto.

In the following descriptions, each device that constitutes the ground radio communication system is also referred to as a “communication infrastructure device”, and the ground radio communication system is also referred to as a “communication infrastructure”. The management device 15 manages each device that constitutes the ground radio communication system, such as the mobile base station 10 and the core network device 13. That is, the device 15 manages each communication infrastructure device. Specifically, the management device 15 has a function of setting the operation of the mobile base station 10, such as a frequency setting to the mobile base station 10 through the wired line 14, a function of collecting monitoring information that is the result of monitoring the device state of each individual device that constitutes the ground radio communication system, a function of displaying alarm information such as fault information, and other functions. The monitoring information in the present embodiment is described later. It is sufficient that a single management device 15 is provided within the monitoring system 40. However, it is also possible that there are a plurality of management devices 15 within the monitoring system 40. For example, it is possible that the functions of the management device 15 are divided and allocated to two separate management devices, which are provided respectively to process the monitoring information of a communication infrastructure device through the wired line 14, and to process the monitoring information of a communication infrastructure device using a satellite channel.

In the monitoring system 40 according to the present embodiment, the management device 15 collects monitoring information from the mobile base station 10 and the core network device 13 through the wired line 14. The monitoring information indicates the result of monitoring the device state of each individual device. In addition to this configuration, in the monitoring system 40 according to the present embodiment, the management device 15 collects the monitoring information of the mobile base station 10 by using a satellite channel.

As illustrated in FIG. 1, a satellite 20 that is an artificial satellite having a communication relaying function, such as a communication satellite, forms a transmission-reception beam, so that a service area 21 of the satellite communication system is constructed by the transmission-reception beam. The transmission-reception beam defines a region where the satellite 20 is capable of transmitting and receiving a satellite radio signal 22b through a data channel. The service area 21 indicates the ground level region, where it is possible to receive a radio wave irradiated by the satellite 20 through the data channel. The satellite 20 is a device that relays communication between the satellite communication terminal 31 and a satellite base station 23. The satellite 20 forms a relay channel by using a satellite radio signal 22a that is a data channel between the satellite 20 and the satellite base station 23, and using the satellite radio signal 22b that is a data channel between the satellite 20 and the satellite communication terminal 31 within the service area 21. It is common that the data channel of the satellite radio signal 22a, and the data channel of the satellite radio signal 22b, use different radio frequencies from each other. The data channel is a channel to be used between the satellite 20 and a communication device that receives service provided by the satellite 20, such as relaying communication.

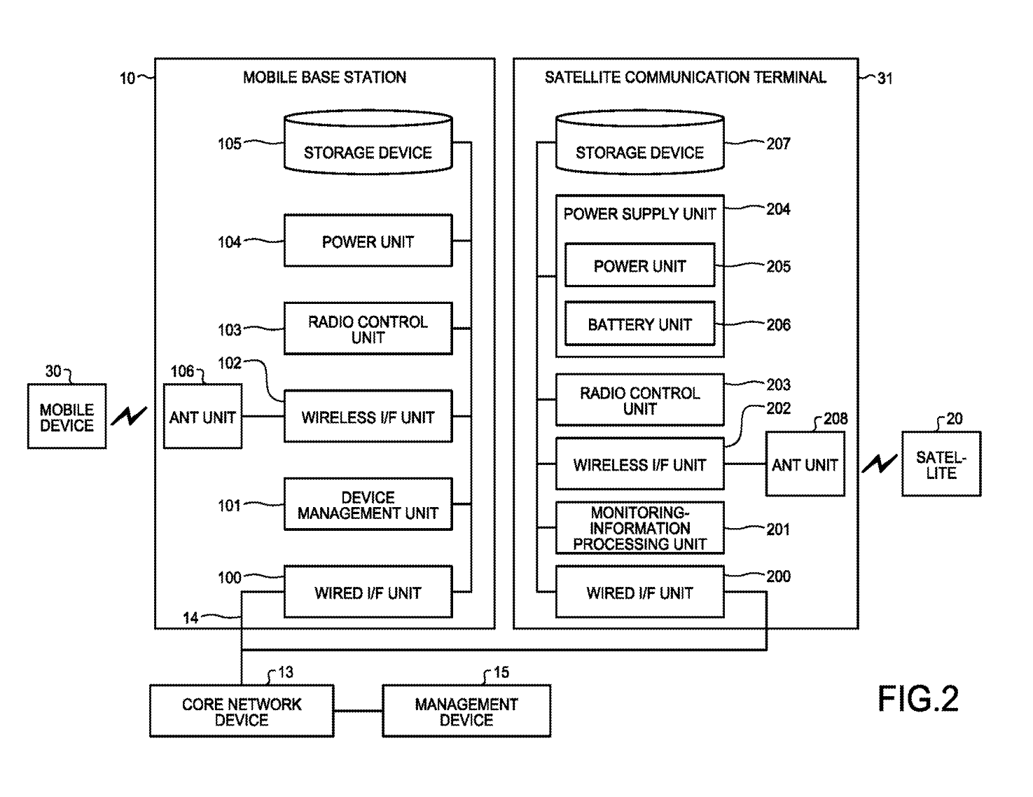

FIG. 2 is a block diagram illustrating a configuration example of the mobile base station 10 and the satellite communication terminal 31 according to the present embodiment.

As illustrated in FIG. 2, the mobile base station 10 includes a wired I/F (Interface) unit 100, a device management unit 101, a wireless I/F unit 102, a radio control unit 103, a power unit 104, a storage device 105, and an antenna unit 106. The wired I/F unit 100 performs a transmission and reception process in conformity with the IP between the mobile base station 10, and the core network device 13, the management device 15, and the satellite communication terminal 31, through the wired line 14.

The device management unit 101 monitors the device state of the mobile base station 10. Specifically, the device management unit 101 monitors, for example, one or more of a hardware state, a wired connection state, a radio communication state, and a power supply state of the mobile base station 10. The hardware state indicates that either irregularities, that is, a fault has occurred in the mobile base station 10, or the mobile base station 10 operates properly. For example, one or more of the constituent elements of the mobile base station 10 are designed to detect a fault in any of the constituent elements, and output an alarm signal. Upon detecting this alarm signal, the device management unit 101 determines that a fault has occurred in the mobile base station 10. An irregular hardware state of the mobile base station 10 indicates that a flow of overcurrent is detected, which results in the device internal temperature becoming a predetermined temperature or higher. Further, in the case where the device is configured by a plurality of substrates, an irregular hardware state indicates that there is no response from any of the substrates when the alive monitoring is performed between the substrates. The method for the device management unit 101 to detect a fault in the mobile base station 10 is not limited thereto. It is possible that the device management unit 101 uses any method as long as the method can detect a fault within the mobile base station 10. The wired connection state indicates whether a communication path between the mobile base station 10 and the core network device 13 is properly established through the wired I/F unit 100. An example of the bath establishment procedure is described later. Furthermore, the mobile base station 10 detects an irregular wired connection state when the Ethernet® connection link is down, or when the alive monitoring is performed using “HEARTBEAT” between the mobile base station 10 and the core network device 13 as defined in the SCTP (Stream Control Transmission Protocol), and then the mobile base station 10 does not receive any response from a counterpart device for a given period of time (or a given number of times). The radio communication state indicates a state in which the mobile base station 10 has detected the radio communication state to be either normal or abnormal. The mobile base station 10 detects an irregular radio communication state, for example, when it detects that a radio wave cannot be transmitted due to irregularities of a transmission amplifier, or when the mobile base station 10 has detected upload data, but cannot receive it for a long period of time, or when the mobile base station 10 cannot maintain the frequency accuracy that satisfies the radio standards due to clock irregularities. The mobile base station 10 detects an irregular power supply state when the voltage/current (power) is decreased, or when the temperature in the power device is increased irregularly.

The antenna unit 106 transmits and receives the mobile radio signal 12 to and from the mobile device 30. In the following descriptions, the antenna unit is abbreviated as an “ANT unit” in the diagrams. The wireless I/F unit 102 performs a process of transmitting and receiving the mobile radio signal 12 in conformity with the communication standards of the mobile base station 10 and mobile phones. The radio control unit 103 performs a process of establishing a radio connection with the mobile device 30. The power unit 104 has a function of supplying power, provided from an external power supply such as a system power supply, to each unit within the ground base station 10. The power unit 104 is also capable of supplying power by using the power, provided from a power generator such as a photovoltaic power-generation device, at the time of a power outage in the external power supply. The storage device 105 stores therein the internal information needed for operating the mobile base station 10, and other information. The internal information needed for operating the mobile base station 10 includes operational information received from the management device 15 in a processing procedure at the startup described later. The internal information needed for operating the mobile base station 10 is information of a frequency in use (a band), transmission power, radio control information (a retransmission parameter, the number of times of retransmission, a channel configuration, and parameters that are not dynamically variable), the IP address (fixed assignment) of the mobile base station 10 itself and its peripheral devices, the IP address acquisition method (automatic assignment), or other information.

As illustrated in FIG. 2, the satellite communication terminal 31 includes a wired I/F unit 200, a monitoring-information processing unit 201, a wireless I/F unit 202, a radio control unit 203, a power supply unit 204, a storage device 207, and an antenna unit 208. The wired I/F unit 200 performs a transmission and reception process in conformity with the IP between the mobile base station 10, the core network device 13, the management device 15, and other devices, through the wired line 14. That is, the unit 200 communicates with the mobile base station 10, the core network device 13, the management device 15, and other devices, through the wired line 14. The wired I/F unit 200 is a first communication unit that receives monitoring information from the mobile base station 10 that is a target device whose device state is monitored. The monitoring information is the result of monitoring the device state of the target device. The monitoring-information processing unit 201 performs a process applied to the monitoring information received from the mobile base station 10 through the wired I/F unit 200, on the basis of the monitoring-information processing policy information stored in the storage device 207. That is, the monitoring-information processing unit 201 is a processing unit that selects the monitoring information, to be transferred to the wired I/F unit 200, from among the various pieces of monitoring information received from the mobile base station 10, on the basis of the monitoring-information processing policy information that is transfer information, and then transfers the selected monitoring information to the wired I/F unit 200. The monitoring-information processing policy information is information that indicates a process to be performed on the received monitoring information by the satellite communication terminal 31 on the basis of each niece of information stored in the monitoring information. In other words, the monitoring-information processing policy information is transfer information that indicates conditions for selecting the monitoring information, to be transferred to the wired I/F unit 200, from among the various pieces of monitoring information. The monitoring-information processing policy information is described later in detail. The ANT unit 208 transmits and receives the satellite radio signal 22b to and from the satellite 20 through a data channel. The wireless I/F unit 202 performs a process of transmitting and receiving the satellite radio signal 22b in conformity with the satellite communication protocol. Any protocol can be used as a satellite communication protocol. The radio control unit 203 performs a process of establishing a radio connection with the satellite 20. The wireless I/F unit 202 is a second communication unit that performs radio communication with the satellite 20, and that communicates with the management device 15 through the satellite 20.

The power supply unit 204 is configured by a power unit 205 and a battery unit 208. The power unit 205 supplies power, provided from an external power supply, to each unit within the satellite communication terminal 31. The battery unit 206 is a battery to be charged while the power is supplied from the external power supply. If a power supply from the external power supply is stopped due to a power outage or the like, the battery unit 206 supplies the accumulated power to each unit within the satellite communication terminal 31. The storage device 207 stores therein the internal information needed for the operation of the satellite communication terminal 31, and the information processing policy information. Examples of the internal information needed for the operation of the satellite communication terminal 31 include a frequency to be used for communication with the satellite 20, which is obtained in the process of establishing communication with the satellite 20.

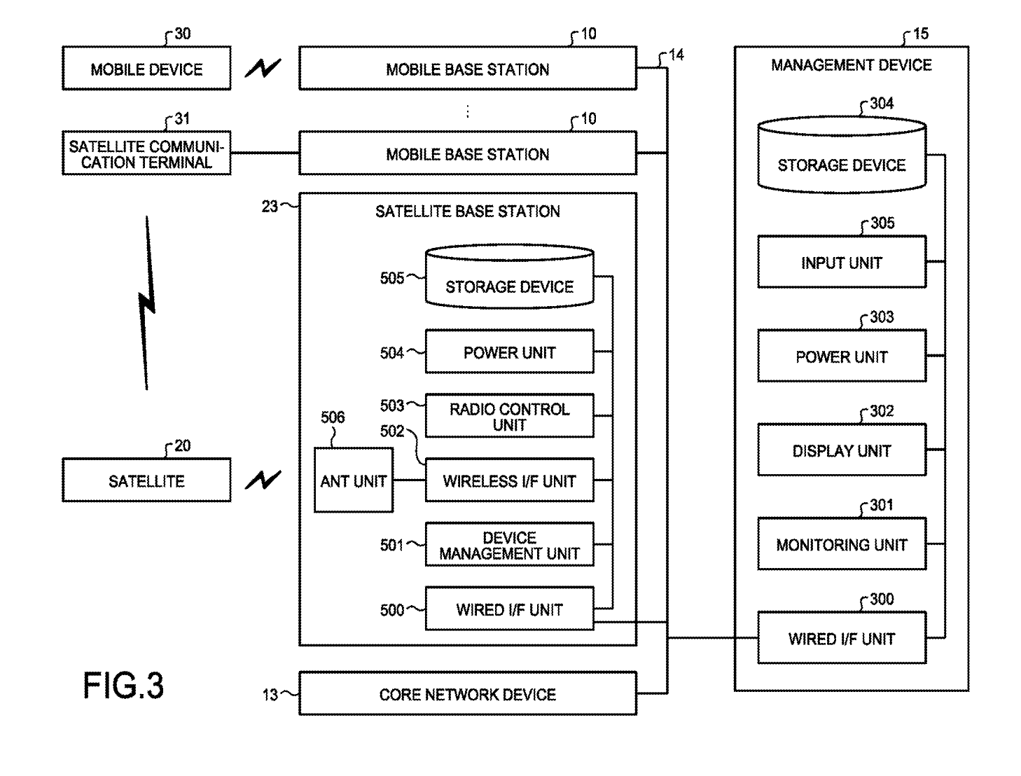

FIG. 3 is a block diagram illustrating a configuration example of the management device 15, and the satellite base station 23 according to the present embodiment. The management device 15 includes a wired I/F unit 300, a monitoring unit 301, a display unit 302, a power unit 303, a storage device 304, and an input unit 305. The wired I/F unit 300 is connected to a plurality of mobile base stations 10, the satellite base station 23, and the core network device 13. The monitoring unit 301 collects and manages the information associated with the device state of the communication infrastructure devices such as the mobile base stations 10 and the core network device 13, and controls display of the information associated with the device state of the communication infrastructure devices on the display unit 302. Further, the monitoring unit 301 manages the operational information to be transmitted to each communication infrastructure device. Specifically, the monitoring unit 301 generates operational information to be transmitted to each communication infrastructure device, and notifies the operational information of each communication infrastructure device through the wired I/F unit 300. Furthermore, the monitoring unit 301 registers, updates, and deletes the monitoring-information processing policy information to be used by the satellite communication terminal 31. The display unit 302 displays the device state regarding the communication infrastructure devices, which is managed by the monitoring unit 301. The input unit 305 receives an operator's input for configuring the settings for the communication infrastructure devices. The power unit 303 supplies power, provided from an external power supply or other devices, to each unit of the management device 15. The storage device 304 stores therein the internal information needed for operating the management device 15, as well as the device-state information that indicates the device state of each communication infrastructure device, and the operational information, both of which are managed by the monitoring unit 301. The internal information needed for operating the management device 15, and the operational information of each communication infrastructure device, are determined in advance, and stored in the storage device 304, for example. The internal information needed for operating the management device 15, and the operational information of each communication infrastructure device, may be changeable on the basis of an external input through the input unit 305. The internal information needed for operating the management device 15 is IP address information (necessary information as a database), information of each communication infrastructure device that is a target to be managed, or other information.

The wired I/F unit 300 is a communication unit that receives monitoring information from the mobile base station 10 through the wired line 14, which is the result of monitoring the device state of the mobile base station 10. The monitoring unit 301 updates the device-state information that indicates the device state of the mobile base station 10 on the basis of the monitoring information received by the wired I/F unit 300. As described later, when the management device 15 cannot receive monitoring information for a given period of time or longer, the monitoring unit 301 generates a monitoring-information setting request that is control information for configuring the settings for a satellite communication device such that the monitoring information is transmitted to the management device 15 itself through the satellite channel via the satellite communication terminal 31 being connected to the mobile base station 10. The monitoring unit 301 updates the device-state information on the basis of the monitoring information received through the satellite communication terminal 31 and the satellite channel.

The satellite base station 23 includes a wired I/F unit 500, a device management unit 501, a wireless I/F unit 502, a radio control unit 503, a power unit 504, a storage device 505, and an antenna unit 506. The wired I/F unit 500 performs a transmission and reception process in conformity with the IP between the satellite base station 23, and the core network device 13 and the management device 15, through the wired line 14.

The device management unit 501 monitors the device state of the satellite base station 23. The antenna unit 506 transmits and receives the satellite radio signal 22a to and from the satellite 20. The wireless I/F unit 502 performs a process of transmitting and receiving the satellite radio signal 22a to and from the satellite 20. The radio control unit 503 performs a process of establishing a radio connection with the satellite 20. The power unit 504 supplies power, provided from an external power supply such as a system power supply, to each unit within the satellite base station 23. The storage device 505 stores therein the internal information needed for operating the satellite base station 23, and other information. The internal information needed for operating the satellite base station 23 includes operational information received from the management device 15 in a processing procedure at the startup described later. The internal information needed for operating the satellite base station 23 is satellite beam orientation information, information of a frequency in use (a band allocated to the beam), transmission power, radio control information (a retransmission parameter, the number of times of retransmission, and parameters that are not dynamically variable), the IP address (fixed assignment) of the satellite base station 23 itself and its peripheral devices, the IP address acquisition method (automatic assignment), or other information.

Next, the hardware configuration of the mobile base station 10, the satellite communication terminal 31, the management device 15, and the satellite base station 23, is described. Each constituent unit of the mobile base station 10 illustrated in FIG. 2 can be implemented by hardware such as an electronic circuit or the like. The ANT unit 106 is configured by an antenna, and a processing circuit that is an electronic circuit such as a frequency conversion circuit, an amplifier, or an analog-digital converter. Each of the wired I/F unit 100 and the wireless I/F unit 102 is a communication interface circuit. The radio control unit 103 is implemented by a processing circuit that is an electronic circuit that executes a radio control in conformity with the communication standards in the mobile phone system and the satellite communication system. The power unit 104 is a power supply circuit that supplies power. The storage device 105 is a memory. The device management unit 101 is a processing circuit that is an electronic circuit that performs a device management process.

It is possible that the processing circuit that implements the device management unit 101, and the processing circuit that implements the radio control unit 103, are either dedicated hardware or a control circuit that includes a memory, and a CPU (Central Processing Unit, which is also referred to as a “processing device”, “computation device”, a “microprocessor”, a “microcomputer” a “processor”, or a DSP (Digital Signal Processor)) that executes a program stored in the memory. Examples of the memory include a nonvolatile or volatile semiconductor memory, such as a RAM (Random Access Memory), a ROM (Read Only Memory), a flash memory, an EPROM (Erasable Programmable Read Only Memory), or an EEPROM (Electrically Erasable Programmable Read Only Memory), and also include a magnetic disk, a flexible disk, an optical disk, a compact disk, a minidisk, and a DVD (Digital Versatile Disk).

In the case where each of the device management unit 101 and the radio control unit 103 is implemented by dedicated hardware, these units are, for example, a single circuit, a combined circuit, a programmed processor, a parallel-programmed processor, an ASIC (Application Specific Integrated Circuit), an FPGA (Field Programmable Gate Array), or a combination thereof.

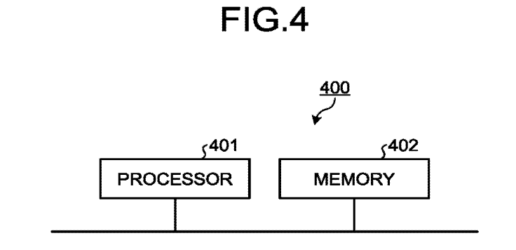

In the case where each of the device management unit 101 and the radio control unit 103 is implemented by a control circuit that includes a CPU, this control circuit is, for example, a control circuit 400 that is configured as illustrated in FIG. 4. As illustrated in FIG. 4, the control circuit 400 includes a processor 401 that is a CPU, and a memory 402. In the case where the device management unit 101 is implemented by the control circuit 400 illustrated in FIG. 4, the processor 401 reads and executes a program that is stored in the memory 402, and that corresponds to the processing in each of the device management unit 101 and the radio control unit 103, thereby implementing the unit. The memory 402 is used also as a temporary memory for each process to be performed by the processor 401.

Each constituent unit of the satellite communication terminal 31 illustrated in FIG. 2 can be implemented by hardware such as an electronic circuit or the like. The ANT unit 208 is configured by an antenna, and a processing circuit that is an electronic circuit such as a frequency conversion circuit, an amplifier, or an analog-digital converter. Each of the wired I/F unit 200 and the wireless I/F unit 202 is a communication interface circuit. The radio control unit 203 is a processing circuit that is an electronic circuit that executes a radio control in conformity with the communication standards in the satellite communication system. The battery unit 206 in the power supply unit 204 is a battery. The power unit 205 in the power supply unit 204 is a power supply circuit that supplies power. The storage device 207 is a memory. The monitoring-information processing unit 201 is a processing circuit that is an electronic circuit that processes the monitoring information.

It is possible that the processing circuit that implements the monitoring-information processing unit 201, and the processing circuit that implements the radio control unit 203, are either dedicated hardware or a control circuit including a memory, and a CPU that executes a program stored in the memory. In the case where the monitoring-information processing unit 201 is implemented by dedicated hardware, this unit is, for example, a single circuit, a combined circuit, a programmed processor, a parallel-programmed processor, an ASIC, an FPGA, or a combination thereof.

In the case where each of the monitoring-information processing unit 201 and the radio control unit 203 is implemented by a control circuit that includes a CPU, this control circuit is, for example, the control circuit 400 that is configured as illustrated in FIG. 4. In the case where the monitoring-information processing unit 201 is implemented by the control circuit 400 illustrated in FIG. 4, the processor 401 reads and executes a program that is stored in the memory 402, and that corresponds to the processing in each of the monitoring-information processing unit 201 and the radio control unit 203, thereby implementing the unit. The memory 402 is used also as a temporary memory for each process to be performed by the processor 401.

Each constituent unit of the management device 15 illustrated in FIG. 3 can be implemented as hardware such as an electronic circuit or the like. The wired I/F unit 300 is a communication interface circuit. The display unit 302 is a display. The power unit 303 is a power supply circuit. The input unit 305 is a reception device. The storage device 304 is a memory. The monitoring unit 301 is a processing circuit that is an electronic circuit that performs a monitoring process.

It is possible that the processing circuit that implements the monitoring unit 301 is either dedicated hardware or a control circuit including a memory, and a CPU that executes a program stored in the memory. In the case where the monitoring unit 301 is implemented by dedicated hardware, this unit is, for example, a single circuit, a combined circuit, a programmed processor, a parallel-programmed processor, an ASIC, an FPGA, or a combination thereof.

In the case where the monitoring unit 301 is implemented by a control circuit that includes a CPU, this control circuit is, for example, the control circuit 400 that is configured as illustrated in FIG. 4. In the case where the monitoring unit 301 is implemented by the control circuit 400 illustrated in FIG. 4, the processor 401 reads and executes a program that is stored in the memory 402, and that corresponds to the processing in the monitoring unit 301, thereby implementing the unit. The memory 402 is used also as a temporary memory for each process to be performed by the processor 401.

Each constituent unit of the satellite base station 23 illustrated in FIG. can be implemented as hardware such as an electronic circuit or the like. The ANT unit 506 is configured by an antenna, and a processing circuit that is an electronic circuit such as a frequency conversion circuit, an amplifier, or an analog-digital converter. Each of the wired I/F unit 500 and the wireless I/F unit 502 is a communication interface circuit. The radio control unit 503 is a processing circuit that executes a radio control in conformity with the communication standards in the satellite communication system. The power unit 504 is a power supply circuit that supplies power. The storage device 505 is a memory. The device management unit 501 is a processing circuit that is an electronic circuit that performs a device management process.

It is possible that the processing circuit that implements the device management unit 501, and the processing circuit that implements the radio control unit 503, are either dedicated hardware or a control circuit including a memory, and a CPU that executes a program stored in the memory. In the case where the device management unit 501 is implemented by dedicated hardware, this unit is, for example, a single circuit, a combined circuit, a programmed processor, a parallel-programmed processor, an ASIC, an FPGA, or a combination thereof.

In the case where each of the device management unit 501 and the radio control unit 503 is implemented by a control circuit that includes a CPU, this control circuit is, for example, the control circuit 400 that is configured as illustrated in FIG. 4. In the case where the device management unit 501 is implemented by the control circuit 400 illustrated in FIG. 4, the processor 401 reads and executes a program that is stored in the memory 402, and that corresponds to the processing in each of the device management unit 501 and the radio control unit 503, thereby implementing the unit. The memory 402 is used also as a temporary memory for each process to be performed by the processor 401.

Next, the operation of the monitoring system 40 in the present embodiment is described. First, there is described a procedure, which is used from when the mobile base station 10 and the satellite base station 23 are started-up, then a path is established between the mobile base station 10 and the core network device 13, and then service of the ground radio communication system is started, to when the management device 15 starts monitoring the communication infrastructure. That is, a processing procedure at the startup of the mobile base station 10 and the satellite base station 23 is described.

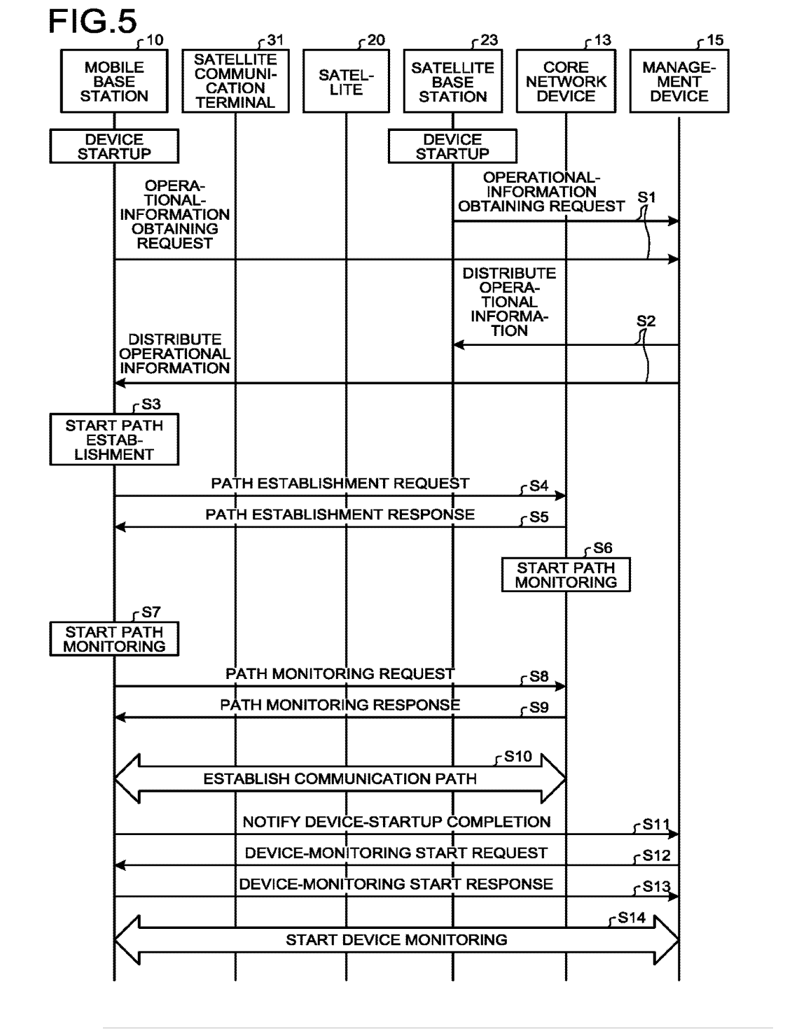

FIG. 5 is a sequence diagram illustrating an example of the processing procedure at the startup of the mobile base station 10 and the satellite base station 23 in the present embodiment. When the mobile base station 10 and the satellite base station 23 are started-up, each of these devices transmits to the management device 15 an operational-information obtaining request for obtaining operational information to be used for operating the device (Step S1). Specifically, the device management unit 101 in the mobile base station 10 generates and transmits an operational-information obtaining request to the management device 15 through the wired I/F unit 100. Further, the device management unit 501 in the satellite base station 23 generates and transmits an operational-information obtaining request to the management device 15 through the wired I/F unit 500. The storage device 105 in the mobile base station 10, and the storage device 505 in the satellite base station 23 have stored therein the IP address of the management device 15 as the internal information. The device management unit 101, and the device management unit 501 read this IP address of the management device 15 from the storage device 105 and the storage device 505, respectively, and store the IP address in an IP packet that is the operational-information obtaining request as its destination. The IP packet is a packet in a format that complies with the IP. Each of the storage device 105 and the storage device 505 has stored therein the IP address of its own device, that is, the mobile base station 10 and the satellite base station 23. This IP address is stored as a transmission source of the IP packet that is the operational-information obtaining request to be transmitted from the mobile base station 10 and the satellite base station 23. It is also possible that individual IP addresses of the mobile base station 10 and the satellite base station 23 are not determined in advance, but are assigned from the management device 15 or other devices. In this case, prior to transmission of an operational-information obtaining request, a process of acquiring an IF address in conformity with the IP is performed.

Upon receiving an operational-information obtaining request from the mobile base station 10 and the satellite base station 23, the management device 15 reads operational information for the mobile base station 10, and operational information for the satellite base station 23, which are stored in the storage device 304, and then distributes, that is, transmits the corresponding operational information to the mobile base station 10 and to the satellite base station 23 (Step S2). Specifically, in the management device 15, upon receiving an operational-information obtaining request from the mobile base station 10 through the wired I/F unit 300, the monitoring unit 301 reads operational information for the mobile base station 10 from the storage device 304, and transmits the read operational information to the mobile base station 10 through the wired I/F unit 300. In addition, in the management device 15, upon receiving an operational-information obtaining request from the satellite base station 23 through the wired I/F unit 300, the monitoring unit 301 reads operational information for the satellite base station 23 from the storage device 304, and transmits the read operational information to the satellite base station 23 through the wired I/F unit 300.

The operational information be distributed by the management device 15 to the mobile base station 10 includes frequency information that indicates a frequency band to be used for transmitting and receiving the mobile radio signal 12, transmission power information that indicates transmission power when the mobile base station 10 transmits the mobile radio signal 12, connection information for being connected to the core network device 13 that is a higher-level device that monitors the path, and other information. Examples of the connection information for being connected to the core network device 13 include IP address information of the core network device 13. The operational information, to be distributed by the management device 15 to the satellite base station 23, includes setting information associated with the satellite 20, which is used for the management system in the present embodiment to monitor the ground radio communication system. Examples of this setting information include beam orientation in the satellite 20, frequency assignment information that indicates a frequency to be used to each beam by the satellite 20, power allocation information that indicates transmission power for each beam, and identification information of a beam and the mobile base station 10 within the beam irradiated area. Further, the operational information, to be distributed by the management device 15 to the satellite base station 23, includes connection information for being connected to the core network device 13, and other information.

In the mobile base station 10, the device management unit 101 uses the information included in the received operational information to set up the wireless I/F unit 102 and other units, in order to start mobile phone service. In the satellite base station 23, the device management unit 501 transmits the setting information included in the received operational information as the satellite radio signal 22a to the satellite 20 through the wireless I/F unit 502 and the antenna unit 506. Satellite communication service is thereby started.

Upon completion of the settings to start mobile phone service, the device management unit 101 in the mobile base station 10 tarts path establishment in order to monitor the communication path between the mobile base station 10 and the core network device 13 (Step S3). The path establishment is performed in conformity with the path monitoring protocol. There are typical path monitoring protocols such as the SCTP (Stream Control Transmission Protocol) that is a transport layer protocol. However, the path monitoring protocol is not limited thereto. The device management unit 101 in the mobile base station 10 generates a path establishment request that requests the start of path establishment, and transmits the request to the core network device 13 through the wired I/F unit 100 (Step S4). The path establishment request includes a connection-destination IP address of the core network device 13, which is needed for IP transmission between the mobile base station 10 and the core network device 13. In the case where a plurality of wired I/Fs are used to use a plurality of IP transmission paths, the path establishment request includes plural pieces of IP address information. The core network device 13 transmits to the mobile base station 10 a path establishment response that is a response to the path establishment request (Step S5). The path establishment is completed through the process described above.

Upon completion of the path establishment, the device management unit 101 in the mobile base station 10, and the core network device 13 start path monitoring (Steps S6 and S7). As described above, as a path monitoring method, the SCTP can be used, for example. When the device management unit 101 in the mobile base station 10, and the core network device 13 have started path monitoring, the device management unit 101 in the mobile base station 10 transmits a path monitoring request to the core network device 13 (Step S8). The core network device 13, having received the path monitoring request, returns a path monitoring response (Step S9). Due to this operation, a communication path is established between the mobile base station 10 and the core network device 13 (Step S10).

The device management unit 101 in the mobile base station 10 transmits a device-startup completion notification for notifying completion of the device startup to the management device 15 through the wired I/F unit 100 (Step S11). The monitoring unit 301 in the management device 15 transmits a device-monitoring start request that requests the start of monitoring the device state of the mobile base station 10 through the wired I/F unit 300 to the mobile base station 10 (Step S12). In the mobile base station 10, upon receiving the device-monitoring start request through the wired I/F unit 100, the device management unit 101 generates a device-monitoring start response to the management device 15, which is a response that allows the mobile base station 10 itself to be a target to be monitored, and transmits this response to the management device 15 through the wired I/F unit 100 (Step S13). Thereafter, the device management unit 101 starts monitoring its own device, that is, monitoring the device state (Step S14). The device management unit 101 performs the device monitoring, that is, monitors the device state, to generate monitoring information that is the result of monitoring the device state. The monitoring information is information that individually indicates the hardware state, the wired connection state, the radio communication state, the power supply state which are described previously, and other states. That is, the monitoring information includes hardware information that indicates the hardware state, wired connection information that indicates the wired connection state, radio communication information that indicates the radio communication state, power supply information that indicates the power supply state, and other information.

As a device monitoring method, the SNMP (Simple Network Management Protocol), which uses the management information referred to as a “MIB (Management Information Base)”, the ZIP (Customer Premises Equipment WAN Management Protocol), designed to remotely manage customer premises equipment, and standardized by Broadband Forum, or other protocols can be used. However, the device monitoring method is not limited thereto.

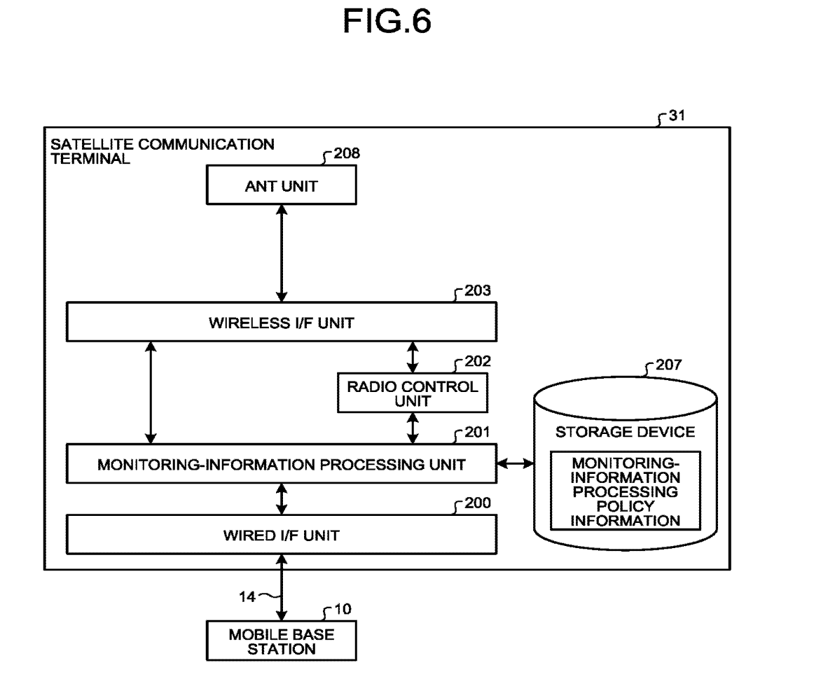

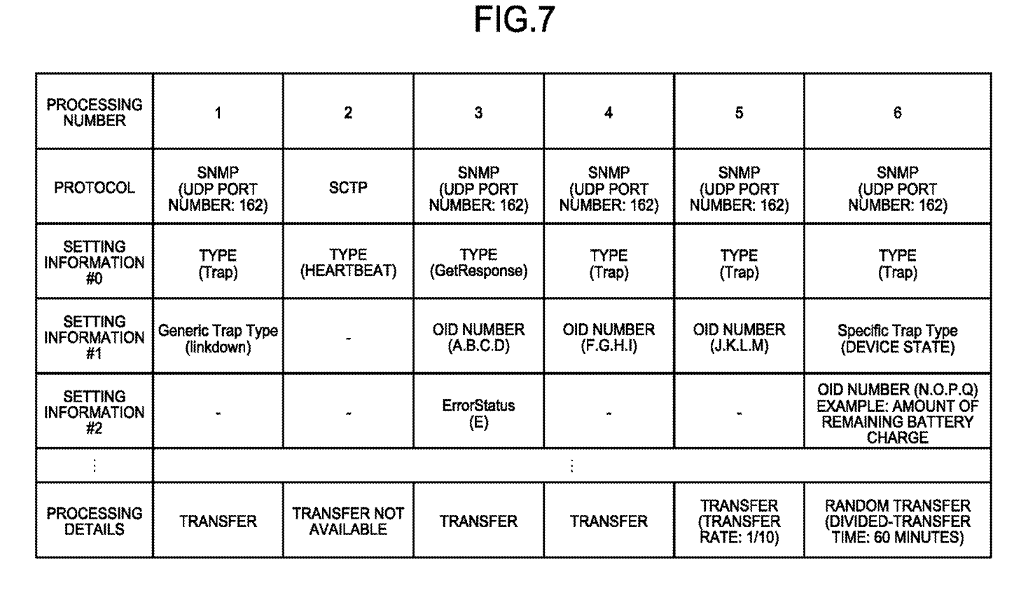

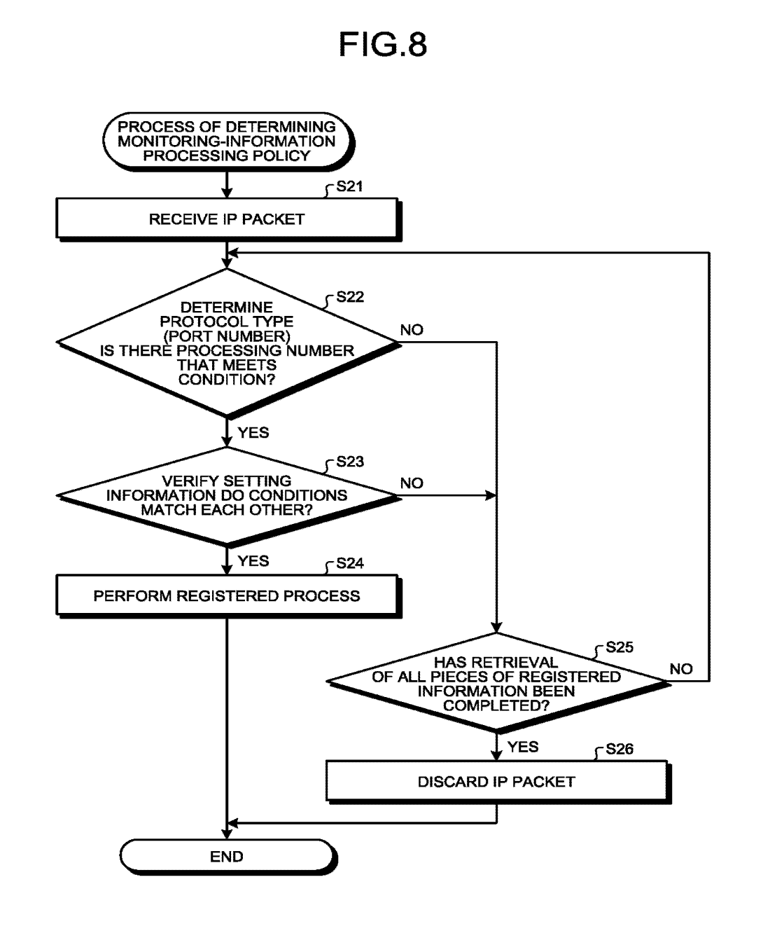

FIG. 6 is a block diagram illustrating an example of the data transfer path of the satellite communication terminal 31 in the present embodiment. FIG. 7 is a diagram illustrating a configuration example of the monitoring-information processing policy information table saved in the satellite communication terminal 31 according to the present embodiment. FIG. 8 is a flowchart illustrating an example of the process of determining the monitoring-information processing policy in the satellite communication terminal 31 according to the present embodiment.

With reference to FIGS. 6, 7, and 8, a data transfer process in the satellite communication terminal 31 according to the present embodiment is described below. The monitoring-information processing policy information is information that indicates a monitoring-information processing policy that is a policy that describes how to perform the monitoring information processing. The monitoring-information processing policy information is information that defines the processing to be performed by the satellite communication terminal 31 on the monitoring information received from the mobile base station 10 via the wired line 14. In the present embodiment, the mobile base station 10 transmits the monitoring information to the management device 15 through the wired I/F unit 100, the wired line 14, and the core network device 13, that is, not via the satellite communication terminal 31. The type of monitoring information to be transmitted, and the transmission timing of the monitoring-information are instructed by the management device 15.

In addition to this configuration, in the present embodiment, the mobile base station 10 transmits the monitoring information also to the satellite communication terminal 31 through the wired I/F unit 100. It is also possible that the satellite communication terminal 31 has a function of monitoring the information to be transmitted from the wired I/F unit 100 in the mobile base station 10 through the wired line 14 to the core network device 13. Due to this configuration, the mobile base station 10 can transmit the monitoring information to the management device 15 via the satellite communication terminal 31, the satellite 20, the satellite base station 23, and the core network device 13, that is, via the satellite channel. A path, extending through the mobile base station 10, the wired line 14, the core network device 13, and the management device 15, is appropriately referred to as a “wired path”. Meanwhile, when the mobile base station 10 is capable of transmitting monitoring information to the management device 15 without via the satellite channel and still transmits monitoring information to the management device 15 via the satellite channel, then the satellite channel resource not used efficiently. Therefore, in the present embodiment, the satellite communication terminal 51 uses the monitoring-information processing policy information to determine the processing to be performed on an IP packet received from the mobile base station 10 according to the details of the IP packet. With this monitoring-information processing policy information, unnecessary monitoring information is determined not to be transferred through the satellite channel. Accordingly, if a fault has occurred on the wired path between the mobile base station 10 and the management device 15 due to disaster or the like, the management device 15 can obtain the monitoring information from the mobile base station 10 with minimal use of the satellite channel resource.

As illustrated in FIG. 7, the monitoring-information processing policy information stored in the storage device 207 is constituted with the processing number, the verification data that is information indicating the conditions for data verification, and the processing details when the data matches the verification data. The verification data is constituted with the protocol type, the setting information, and other data. Setting information #0, processing information #1, and . . . in FIG. 7 are the aforementioned setting information. As illustrated in FIG. 7, it is possible that there are plural types of setting information. In FIG. 7, the protocol type is abbreviated as a “protocol”. The setting information indicates an item to be verified in an IP packet, and the value of the item. It is possible that the number of types of setting information, to be used as verification data, differs between the processing numbers. In FIG. 7, there are two types of setting information to the processing number 1, which are the setting information #0 and the setting information #1, while there is one type of setting information to the processing number 2, which is the setting information #0. The processing details are information that indicates the processing to be performed by the satellite communication terminal 31 on the monitoring information that matches the verification data. FIG. 7 illustrates an example, in which the monitoring-information processing policy information is constituted with the verification data and the processing details. However, it is sufficient that the monitoring-information processing policy information includes at least the conditions of the target monitoring information to be transferred. That is, it is sufficient that there is not the row “processing details”. For example, in the case where only the availability of information transfer is determined, it is sufficient that the verification data of the target monitoring information to be transferred, that is, the target monitoring information to be transferred, is stored in the monitoring-information processing policy information. In this case, data that matches the conditions shown in the monitoring-information processing policy information is transferred, while data that does not match those conditions is discarded. That is, the monitoring-information processing policy information that is transfer information includes verification data that is the conditions for selecting monitoring information, and information that indicates the processing details corresponding to these conditions. The information that indicates the processing details includes information that indicates whether to transfer or discard the monitoring information that satisfies the corresponding conditions. It is also possible that the processing details include random transfer, and transfer at a predetermined transfer rate, that is, partial transfer, both of which are described later. In the transfer at a predetermined transfer rate, the traffic can be reduced by decreasing the transmission frequency. In the transfer at a predetermined transfer rate, for example, when the transfer rate is defined as 1/10 and 10 packets are received, then any one of the 10 packets is selected and transferred, while the other packets are discarded.

In the column “processing number 1” in FIG. 7, the protocol of the monitoring information received as an IP packet is the SNMP, that is, the UDP (User Datagram Protocol) port number is 162. In addition, the type of received monitoring information is shown as a value that indicates “Trap”. “Generic Trap Type” is shown as a value that indicates “linkdown”. In that case, the processing details, illustrated in the lowest row of the column “processing number 1”, indicate execution of transfer. The format of an SNMP packet is described later.

“OID (ObjectID)” illustrated in FIG. 7 shows an address of the information, that is, a location of the information. For example, the following OID=1.3.6.1.2.1.7.3 shows the details regarding a UDP-data processing error. “Generic Trap Type” is defined by the RFC standards. “Specific Trap Type” shows the information that is not defined as “Generic Trap Type”, but is uniquely added. For example, the processing number 6 in FIG. 7 indicates that the code values of the amount of remaining battery charge (for example, High, Middle, and Low) are uniquely defined as “Specific Trap Type”. In the processing numbers 4 and 5, the determination is performed only on the basis of the OID value.

When the satellite communication terminal receives an IP packet from the mobile base station 10, “transfer” in the monitoring-information processing policy information illustrated in FIG. 7 refers to transferring the monitoring information, received from the mobile base station 10 by the satellite communication terminal 31, to the management device 15 by using the satellite channel. Specifically, at the time of the transfer process, when the satellite communication terminal 31 has not yet established a radio connection with the satellite 20, then the monitoring-information processing unit 201 instructs the radio control unit 202 to transmit a radio connection request. The radio control unit 203 performs the procedure of radio connection establishment with the satellite 20 through the wireless I/F unit 202 and the ANT unit 208. After completion of the radio connection establishment procedure, the radio control unit 203 transfers a target IP packet to the wireless I/F unit 202. Due to this operation, a packet transmitted from the mobile base station 10 is transferred to the satellite communication terminal 31, and then arrives at the management device 15 through the satellite 20, the satellite base station 23, the wired line 14, and the core network device 13. Further, when the satellite communication terminal 31 receives an IP packet from the management device 15 via the wireless I/F unit 202, that is, through the satellite 20, then “transfer” in the monitoring-information processing policy information illustrated in FIG. 7 refers to transferring the monitoring information to the mobile base station 10 through the wired I/F unit 200.

Next, there is described a transfer process using the monitoring-information processing policy information in the satellite communication terminal 31, that is, a process of determining the monitoring-information processing policy. As illustrated in FIG. 3, upon receiving an IP packet from the mobile base station 10 through the wired I/F unit 200 (Step S21), the monitoring-information processing unit 201 references the monitoring-information processing policy information stored in the storage device 207, and determines the protocol type of the received IP packet, that is, the port number, in order to determine whether there is a processing number that meets the condition (Step S22). Specifically, the monitoring-information processing unit 201 extracts the port number from the received IP packet, and determines whether there is a processing number, including the port number that corresponds with the extracted port number, within the monitoring-information processing policy information.

As a result of the determination at Step S22, when there is a processing number in which the port number matches the condition (YES at Step S22), the monitoring-information processing unit 201 verifies the setting information of the applicable processing number within the monitoring-information processing policy information, to determine whether the conditions match each other (Step S23). Specifically, to each setting information of the applicable processing number within the monitoring-information processing policy information, the monitoring-information processing unit 201 determines whether the value of an item, corresponding to the setting information within the received IP packet, corresponds with the value indicated by the setting information within the monitoring-information processing policy information. Subsequently, when the value of an item, corresponding to the setting information within the received IP packet, corresponds with the value indicated by the setting information of the applicable processing number within the monitoring-information processing policy information, then the monitoring-information processing unit 201 determines these conditions match each other.

As a result of the determination at Step S23, when the conditions match each other (YES at Step S23), the monitoring-information processing unit 201 performs a process registered in the corresponding processing number within the monitoring-information processing policy information (Step S24), and then ends the process. As a result of the determination at Step S22, when there is no processing number that meets the condition (NO at Step S22), the monitoring-information processing unit 201 determines whether retrieval of all the pieces of registered information within the monitoring-information processing policy information has been completed, that is, retrieval of all the processing numbers within the monitoring-information processing policy information has been completed (Step S25). When retrieval of all the pieces of registered information within the monitoring-information processing policy information has been completed (YES at Step S25), the monitoring-information processing unit 201 discards the IP packet (Step S26), and then ends the process. As a result of the determination at Step S23, when the conditions do not match each other (NO at Step S23), the process flow advances to Step S25. When the determination at Step S25 is NO (NO at Step S25), the process flow returns to Step S22. There has been described the process in the case when the satellite communication terminal 31 receives an IP packet from the mobile base station 10 through the wired I/F unit 200. However, even when the satellite communication terminal 31 receives an IP packet from the management device 15 through the wireless I/F unit 202, the process of determining the monitoring-information processing policy is still performed in the same manner as illustrated in FIG. 8. The process of determining the monitoring-information processing policy illustrated in FIG. 8 is not necessarily performed on an IP packet received from the management device 15 through the wireless I/F unit 202.

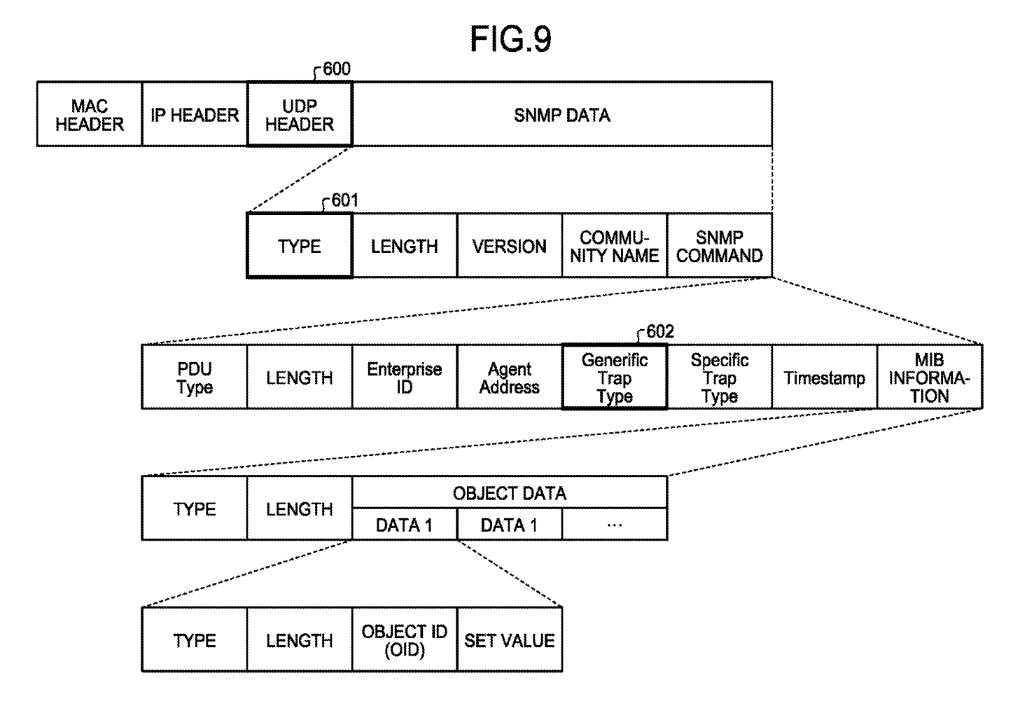

Next, the process of determining the monitoring-information processing policy in the present embodiment is described by using a specific example of the IP packet. FIG. 9 illustrates a format of the SNMP packet. The SNMP packet is constituted with a MAC header, an IP header, a UDP header, and SNMP data that is a data portion generated by the SNMP. In the SNMP packet, the port number within a UDP header 600 illustrated in FIG. 9 is 162, which indicates that the protocol type is the SNMP. The SNMP data includes a type 601 and an SNMP command as illustrated in FIG. 9. The SNMP command includes a Generic Trap Type 602 as illustrated in FIG. 9. As the type 601 of the SNMP packet, there are “Trap”, which indicates an SNMP packet that notifies a state change, that is, the occurrence of irregularities, “GetResponse”, which indicates a response SNMP packet to a request from the SNMP manager, and other types. In the present embodiment, the SNMP manager is the management device 15, and the SNMP agent is the mobile base station 10.

In this example, it is assumed that the mobile base station 10 uses the SNMP as a device monitoring method to transmit an SNMP Trap packet that is an SNMP packet, in which the type 601 within the SNMP packet illustrated in FIG. 9 is set at a value that indicates “Trap”. At this time, a value that indicates “linkdown” is stored as the Generic Trap Type 602 in the SNMP Trap packet transmitted by the mobile base station 10. It is also assumed that as a monitoring-information processing policy, the information illustrated in FIG. 7 is stored in the SNMP Trap packet. In the satellite communication terminal 31, upon receiving the above SNMP Trap packet from the mobile base station 10 via the wired I/F unit 200, the monitoring-information processing unit 201 performs the process illustrated in FIG. 8. Because the port number of the received SNMP Trap packet is 162, which matches the protocol type of the processing numbers 1, 3, 4, 5, and 6 in the monitoring-information processing policy, the determination at Step S22 is YES, and therefore the process flow advances to Step S23. At Step S23, the type in the setting information #0 of the processing number 1 matches the type of the received SNMP Trap packet, and also “Generic Trap Type” in the setting information #1 of the processing number 1 matches “Generic Trap Type” in the received SNMP Trap packet. Therefore, the determination is YES, and the process flow advances to Step S24. At Step S24, “transfer” corresponding to the processing number 1 is executed.

An IP packet, designed to register, update, or delete the monitoring-information processing policy information to be transmitted from the management device 15 to the satellite communication terminal 31 itself, is not targeted for the determination based on the monitoring-information processing policy information. Therefore, regardless of the registered details in the monitoring-information processing policy information, the satellite communication terminal 31 performs an operation instructed by the IP packet, such as registration, update, or deletion of the monitoring-information processing policy information transmitted to the satellite communication terminal 31 itself.

The mobile base station 10 receives a setting command from the management device 15 through a wired path or a path using the satellite channel, where the setting command instructs to configure the settings for the monitoring information to be transmitted to the management device 15. For example, this setting command is issued by following the SNMP. For example, the management device 15 can configure the settings of the mobile base station 10 so as to periodically transmit monitoring information by using an SNMP packet. Upon receiving an SUMP packet designed to set periodic monitoring-information transmission, the mobile base station 10 periodically generates and transmits monitoring information regardless of a change in the monitoring information, that is, regardless of the presence or absence of irregularities.

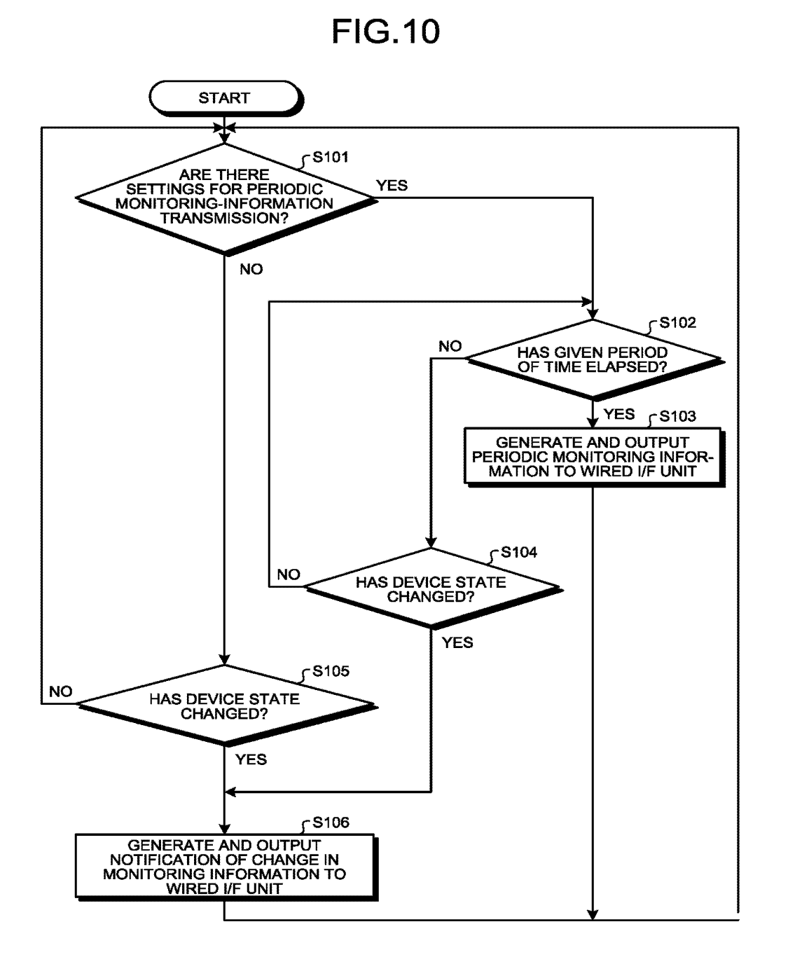

FIG. 10 is a flowchart illustrating an example of the procedure of a device monitoring process in the device management unit 101 of the mobile base station 10 according to the present embodiment. The device management unit 101 determines whether periodic monitoring-information transmission has been set (Step S101). When periodic monitoring-information transmission has been set (YES at Step S101), the device management unit 101 determines whether a given period of time has elapsed since the last monitoring-information transmission (Step S102). When a given period of time has elapsed since the last monitoring-information transmission (YES at Step S102), the device management unit 101 generates periodic monitoring information that is monitoring information to be periodically transmitted, and outputs the information to the wired I/F unit 100 (Step S103). The wired I/F unit 100 transmits the periodic monitoring information to the management device 15 and the satellite communication terminal 31 through the wired line 14. As described above, the periodic monitoring information is transmitted as an SNMP packet, for example. In the periodic monitoring information, the results of monitoring the device state described previously are stored, for example.

When periodic monitoring-information transmission has not been set (NO at Step S101), the device management unit 101 determines whether the device state has changed (Step S105). As described previously, the device state is, for example, the hardware state, the wired connection state, the radio communication state, or the power supply state. In the case where the device state is constituted with a plurality of state-types as described above, when one or more of the state-types have changed, then the device management unit 101 determines that the device state has changed. Generally, a change in the device state indicates that there is a change from the normal state, that is, the device state is abnormal.

When the device state has changed (YES at Step S105), the device management unit 101 generates and outputs a notification of a change in the monitoring information to the wired I/F unit 100 (Step S106), and then the process flow returns to Step S101. The wired I/F unit 100 transmits the notification of a change in the monitoring information to the management device 15 and the satellite communication terminal 31 through the wired line 14. As a notification of a change in the monitoring information, the SNMP Trap packet described previously can be used, for example. When the device state has not changed (NO at Step S105), the process flow returns to Step S101. At Step S102, when a given period of time has not elapsed yet since the last monitoring-information transmission (NO at Step S102), the device management unit 101 determines whether the device state has changed (Step S104). At Step S104, when the device state has changed (YES at Step S104), the process flow advances to Step S106. At Step S104, when the device state has not changed (NO at Step S104), the process flow returns to Step S102.

For example, there is a case where the monitoring unit 301 in the management device 15 cannot receive periodic monitoring information through a wired path from the mobile base station 10, which has been instructed to set the periodic monitoring-information transmission, for a given period of time or longer. In that case, the monitoring unit 301 determines that there is a fault on the wired path, and changes the monitoring information settings so as to obtain the monitoring information through the satellite channel. In the initial state of the monitoring-information processing policy information, transfer of the periodic monitoring information is not set.

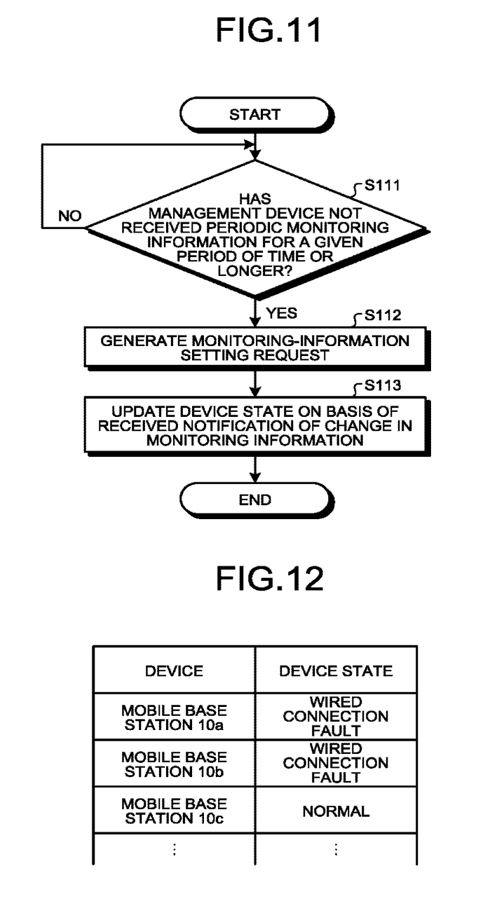

FIG. 11 is a diagram illustrating an example of the procedure of a monitoring-information setting process in the monitoring unit 301 of the management device 1 according to the present embodiment. It is assumed that prior to the start of the process in FIG. 11, the management device 15 has already configured the settings of the mobile base station 10 so as to transmit periodic monitoring information. In the initial state of the monitoring-information processing policy information, transfer of the monitoring information is not set. The monitoring unit 301 determines whether the management device 15 has not received the periodic monitoring information through a wired path for a given period of time or longer (Step S111). When the management device 15 has not received the periodic monitoring information through a wired path for a given period of time or longer (NO at Step S111), the monitoring unit 301 generates a monitoring-information setting request that requests a change in the monitoring information settings, that is, a change in the monitoring-information processing policy information (Step S112). The wired I/F unit 300 transmits the monitoring-information setting request to the satellite base station 23. When the determination is YES at Step S111, Step S111 is repeated.

In the storage device 304 of the management device 15, the IP address of the satellite communication terminal 31 is stored in advance. The monitoring unit 301 stores this IF address in the monitoring-information setting request as its destination. In this monitoring-information setting request, an identifier of the satellite communication terminal as a destination, and an identifier of the mobile base station 10 corresponding to this satellite communication terminal 31, are also stored. In the satellite base station 23, upon receiving the monitoring-information setting request via the wired I/F unit 500, the device management unit 501 determines a beam of the satellite 20 in the area where the satellite communication terminal 31 is present, which is associated with the destination of the monitoring-information setting request. The radio control unit 503 establishes a radio connection with the satellite communication terminal 31, generates a control signal including the monitoring-information setting request, and transmits the control signal to the satellite 20 via the wireless I/F unit 502 and the ANT unit 506. The satellite 20 transmits the monitoring-information setting request by using a beam designated by the control signal. In this manner, the satellite communication terminal 31 receives the monitoring-information setting request. Upon receiving the monitoring-information setting request, the satellite communication terminal 31 changes the monitoring-information processing policy information in the storage device 207 on the basis of the received monitoring-information setting request. In this example, it is assumed that the monitoring information settings have been changed so as to transfer a notification of a change in the monitoring information.

Thereafter, upon receiving the notification of a change in the monitoring information via the satellite channel, the monitoring unit 301 in the management device 15 updates the device-state information having been stored in the storage device 304, on the basis of the received notification of a change in the monitoring information (Step S113), and then ends the process. FIG. 12 is a diagram illustrating an example of the device-state information stored in the storage device 304. As illustrated in FIG. 12, information that indicates the device state of each individual device is stored in the device-state information. It is a communication infrastructure device whose device information is stored within the device-state information. It is possible that the satellite communication terminal 31 is also set as a target to be monitored. The management device 15 transmits a packet addressed to the satellite communication terminal 31 via the satellite channel, then confirms whether the satellite communication terminal 31 operates properly on the basis of the presence of the response to this packet, and then stores therein the information indicating whether the satellite communication terminal 31 operates properly as a device state of the satellite communication terminal 31. As a packet addressed to the satellite communication terminal 31 from the management device 15, a monitoring-information setting request can be used, which is described later.

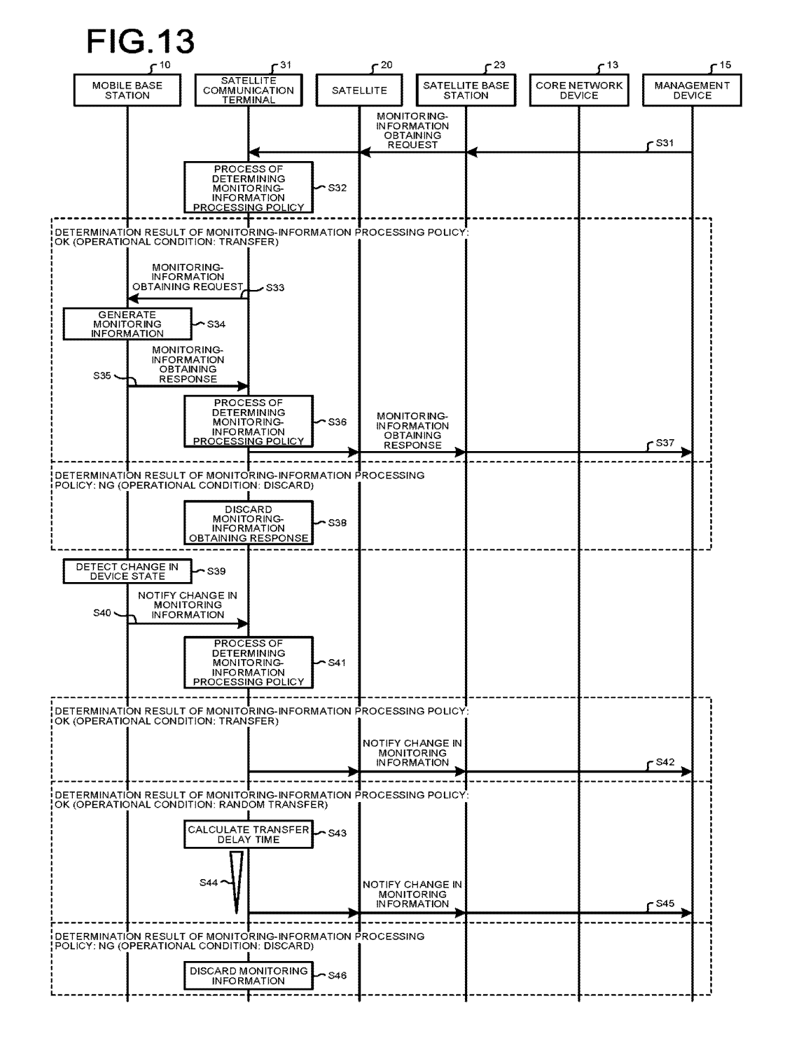

Next, a process of obtaining monitoring information from the mobile base station 10 by the management device 15 is described. FIG. 13 is a sequence diagram illustrating an example of the procedure to obtain monitoring information in the management device 15 according to the present embodiment. The management device 15 transmits a monitoring-information obtaining request to the satellite base station 23 in order to obtain monitoring information from the mobile base station 10 via the satellite channel (Step S31). As a monitoring-information obtaining request, a “Get Request” packet of the SKIMP can be used, for example. Upon receiving a monitoring-information obtaining request via the satellite base station 23 and the satellite 20, the satellite communication terminal 31 performs the aforementioned process of determining the monitoring-information processing policy (Step S32). When there are applicable settings in the monitoring-information processing policy information stored in the storage device 207, then the satellite communication terminal 31 transfers the monitoring-information obtaining request to the mobile base station 10 on the basis of the operation described in the processing details of the monitoring-information processing policy information (Step S33). Upon receiving the monitoring-information obtaining request, the device management unit 101 in the mobile base station 10 generates monitoring information to be transmitted to the management device 15 (Step S34), and stores the monitoring information in a monitoring-information obtaining response that is a response to the monitoring-information obtaining request, so as to transmit the response to the satellite communication terminal 31 (Step S35). The monitoring-information processing unit 201 in the satellite communication terminal 31 performs the process of determining the monitoring-information processing policy (Step S36). When there are applicable settings in the monitoring-information processing policy information, and the processing details specify “transfer”, then the monitoring-information processing unit 201 transfers the monitoring-information obtaining response to the management device 15 via the satellite 20 and the satellite base station 23 (Step S37). When there are no settings applicable the received monitoring-information obtaining response within the monitoring-information processing policy information stored in the storage device 207, or when the processing details, corresponding to the received monitoring-information obtaining response, within the monitoring-information processing policy information, specify “discard”, then the monitoring-information processing unit 201 discards the received monitoring-information obtaining response (Step S38).

Upon detecting a change in the device state (Step S39), the device management unit 101 in the mobile base station 10 generates and transmits a notification of a change in the monitoring information to the satellite communication terminal 31 (Step S40). The device management unit 101 in the mobile base station 10 performs the process of determining the monitoring-information processing policy. As a result of the process of determining the monitoring-information processing policy, when there are applicable settings in the monitoring-information processing policy information, and the processing details specify “transfer”, then the monitoring-information processing unit 201 in the satellite communication terminal 31 transfers a notification of a change in the monitoring information to the management device 15 via the satellite channel (Step S42). As result of the process of determining the monitoring-information processing policy, when there are applicable settings in the monitoring-information processing policy information, and the processing details specify “random transfer”, then the monitoring-information processing unit 201 in the satellite communication terminal 31 calculates a transfer delay time for delaying transfer of the received notification of a change in the monitoring information (Step S43), and starts an internal or external timer to measure an elapsed time with the timer (Step S44). The time required for the expiry of this timer is set as the calculated transfer delay time described above. “Random transfer” as one of the processing details is a process of transferring monitoring information that satisfies the corresponding conditions with a delay. In this process of transferring the monitoring information with a delay, the delay time that is a time for delaying the transfer is calculated so as to be divided to each satellite communication terminal 31, that is, so as to differ between the satellite communication terminals 31 as much as possible.

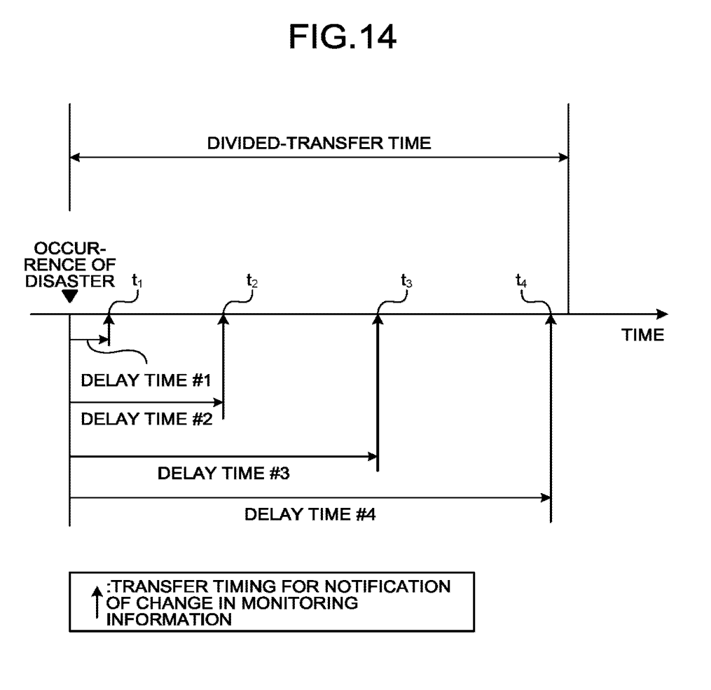

After the expiry of the timer, that is, after the transfer delay time has elapsed, the monitoring-information processing unit 201 transfers a notification of a change in the monitoring information to the management device 15 via the satellite channel (Step S45). The transfer delay time for random transfer is calculated such that the value of transfer delay time differs between a plurality of satellite communication terminals 31 in order to avoid too many simultaneous access requests to the satellite 20 if the device state of the satellite communication terminals 31 changes simultaneously in the event of a disaster. FIG. 14 is a diagram illustrating an example of the transfer delay time when random transfer is performed. First, in order to avoid too many simultaneous access requests to the satellite 20, a divided-transfer time that is the whole transfer period from each satellite communication terminal 31 to the satellite 20, is assumed to be stored in the storage device 207 in each satellite communication terminal 31. For example, the divided-transfer time is notified from the management device 15, and is then stored in the storage device 207. The monitoring-information processing unit 201 in the satellite communication terminal 31 uses this divided-transfer time and a terminal-specific identifier to calculate a transfer delay time on the basis of the following equation (1), for example. “mod” represents a modulus operator.

Transfer delay time=terminal-specific identifier mod divided-transfer time (1)

As a terminal-specific identifier, a characteristic value, which differs between the satellite communication terminals, is used, such as an IMSI (International Mobile Subscriber Identity) stored in the USIM (Universal Subscriber Identity Module) inserted into the satellite communication terminal 31, or an IMEI (International Mobile Equipment Identity) that is the individual number of the satellite communication terminal 31.

When a disaster has occurred, the monitoring-information processing unit 201 calculates a transfer delay time on the basis of this terminal-specific identifier and the divided-transfer time. This makes it possible to calculate a different transfer delay time for each satellite communication terminal 31. That is, the time at which information is transferred from each satellite communication terminal 31 to the satellite channel can be divided. A delay time #1, a delay time #2, a delay time #3, and a delay time #4 in FIG. 14 show respective transfer delay times that differ between the satellite communication terminals 31. The transfer delay time is divided in the manner as described above, and therefore the time, at which information is transferred, that is, the satellite channel is used, is divided to t₁, t₂, t₃, and t₄ as illustrated in FIG. 14. The delay time calculation method using a terminal-specific identifier of the satellite communication terminal 31 is only an example. It is also possible that other calculation methods are used as long as the transfer delay time can be divided.

Referring back to the descriptions in FIG. 13, when there are no settings applicable to the received notification of a change in the monitoring information within the monitoring-information processing policy information, or when the corresponding processing details within the monitoring-information processing policy information specify “discard”, then the monitoring-information processing unit 201 in the satellite communication terminal 31 discards the received notification of a change in the monitoring information (Step S46).

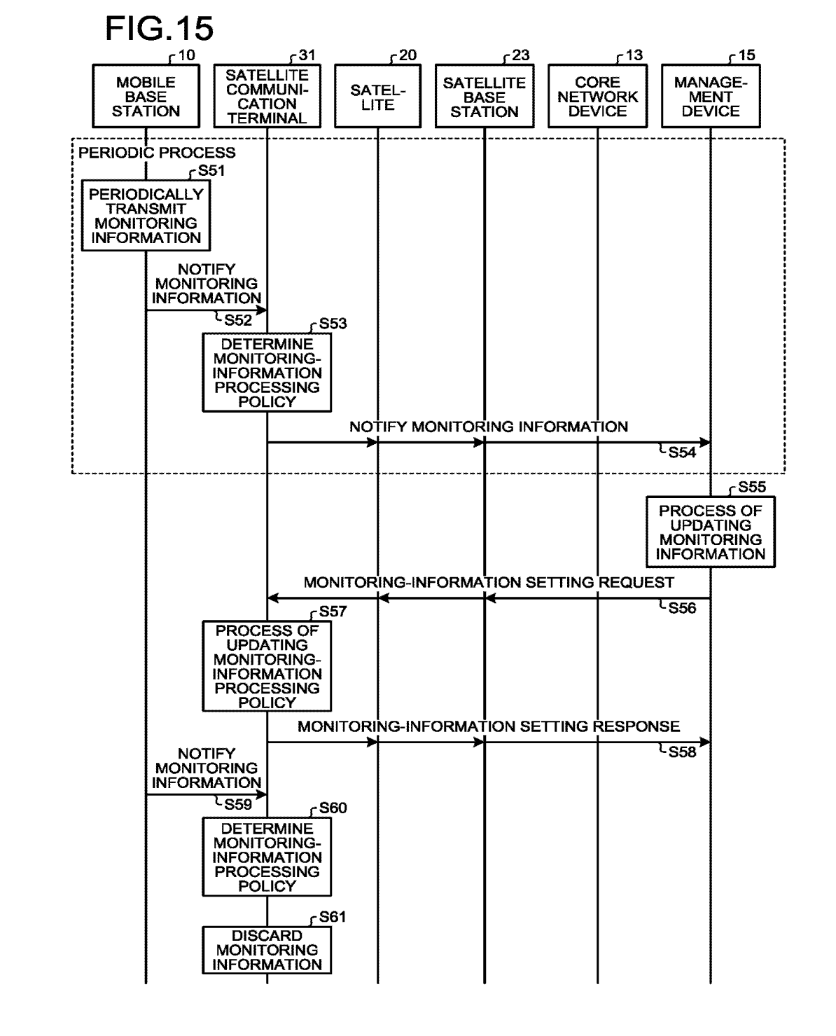

FIG. 15 is a sequence diagram illustrating an example of the procedure to update the monitoring-information processing policy information stored in the satellite communication terminal 31 according to the present embodiment. It is assumed that at the start time-point in the process illustrated in FIG. 15, the values illustrated in FIG. 7 have been already stored in the monitoring-information processing policy information. It is further assumed that the settings to periodically transmit the monitoring information on a request from the management device 15 are applied to the device management unit 101 in the mobile base station 10 (Step S51). The mobile base station 10 periodically generates and transmits monitoring information (Step S52). The satellite communication terminal 1, having received the periodic monitoring information, performs the aforementioned process of determining the monitoring-information processing policy (Step S53), then receives a monitoring information notification applicable to the monitoring-information processing policy information of the processing number 4, and therefore transfers the corresponding message to the management device 15 (Step S54). In this example, assumed that the monitoring information transmitted Step S51 is an SNMP packet that matches the verification data shown as the processing number 4 in the monitoring-information processing policy information.

The monitoring unit 301 in the management device 15 receives an input of the information designed to change the monitoring-information processing policy information from the input unit 305. On the basis of the input information, the monitoring unit 301 performs a monitoring-information updating process, that is, a process of updating the monitoring-information processing policy information to be set in the satellite communication terminal 31 (Step S55). It is possible that at this time, an individual item of the setting details in the monitoring-information processing policy information is either manually input from the input unit 305, or selected from among the setting details registered in the storage device 304 in advance, and then input by the input unit 305. After execution of the monitoring-information updating process, the management device 15 transmits a monitoring-information setting request that is a request for updating the monitoring-information processing policy information to the satellite communication terminal 31 through the wired I/F unit 300 (Step S56). The monitoring-information setting request includes information that specifies which details are to be changed, for example, the processing number, and the items to be changed, that is, the protocol type, the set information #0, the set information #1, and the like. The request also includes the changed details. Furthermore, not only a change in the monitoring information, but also registration of an additional item, processing number, and the like, and deletion of the item and the processing number, can be instructed by a monitoring-information setting request. At this time, it is possible that the monitoring unit 301 updates the monitoring-information processing policy information either individually to each satellite communication terminal 31, or simultaneously to a plurality of satellite communication terminals 31.

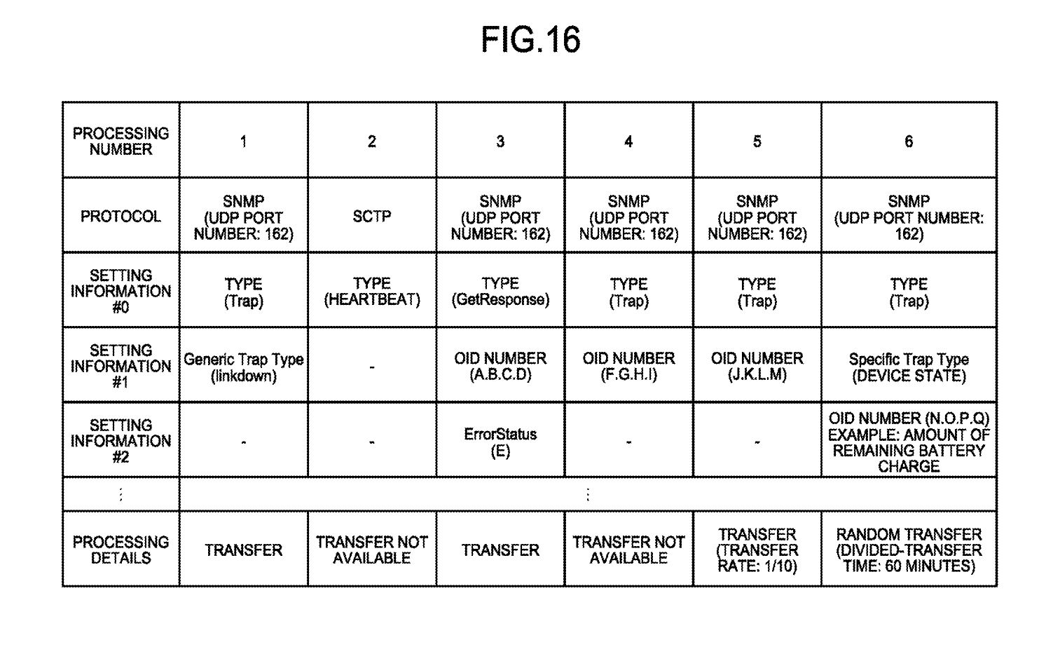

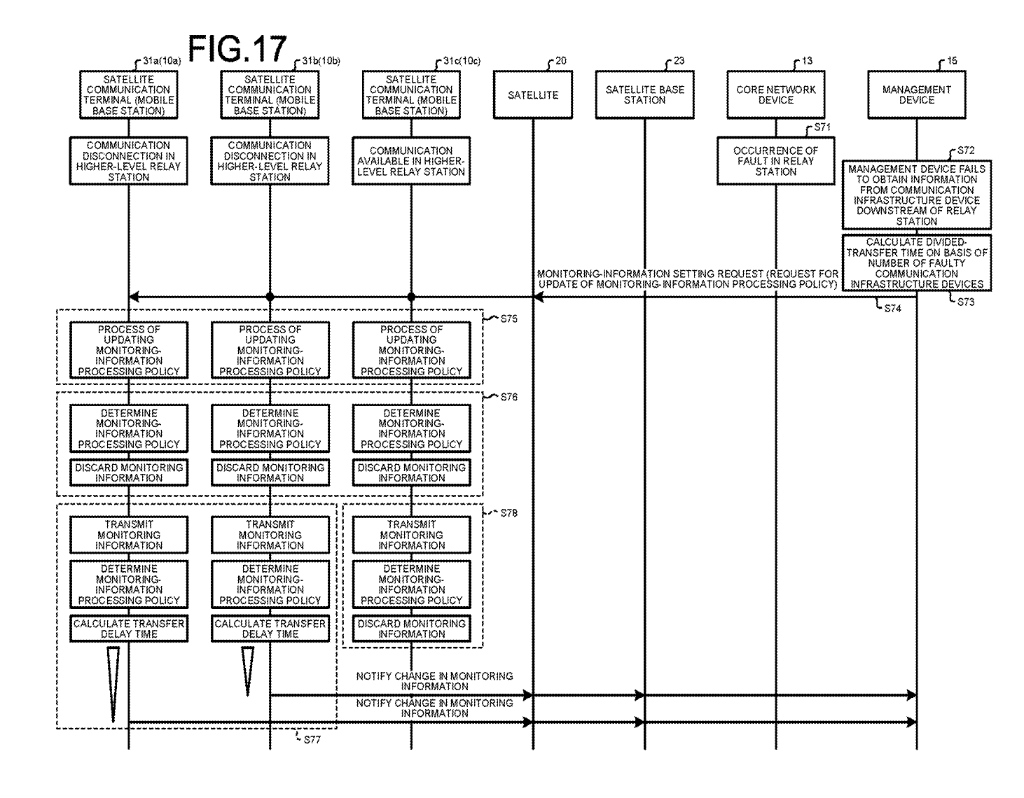

The monitoring-information processing unit 201 in the satellite communication terminal 31, having received the monitoring-information setting request, updates the details of the monitoring-information processing policy information stored in the storage device 207 to the details designated by the monitoring-information setting request (Step S57). FIG. 16 is a diagram illustrating a configuration example of the updated monitoring-information processing policy information table. In this example, the processing details of the processing number 4 in the monitoring-information processing policy information have been changed from “transfer” to “transfer not available”. The monitoring-information processing unit 201, having completed the monitoring-information processing policy updating process, returns a monitoring-information setting response to the management device 15 (Step S58). After the monitoring-information processing policy information has been changed, the device management unit 101 in the mobile base station 10 transmits monitoring information (Step S59). The monitoring information transmitted from the mobile base station 10 is supposed to be monitoring information corresponding to the processing number 4 in the same manner as before the update of the monitoring-information processing policy information. The monitoring-information processing unit 201 in the satellite communication terminal 31, having received the monitoring information, performs a process of determining the monitoring-information processing policy by using the updated monitoring-information processing policy information (Step S60). In the monitoring-information processing policy information of the processing number 4, the processing details specify “transfer not available”. Therefore, the monitoring-information processing unit 201 in the satellite communication terminal 31 discards the received monitoring information (Step S61). Upon receiving the monitoring information, and a monitoring-information control message from the monitoring-information processing unit 201 in the satellite communication terminal 31, the monitoring unit 301 in the management device 15 performs alive confirmation on the satellite communication terminal 31, and then stores its device state in the storage device 304. That is, the monitoring unit 301 in the management device 15 performs alive confirmation on the satellite communication terminal 31 on the basis of whether the management device 15 can receive data from the satellite communication terminal 31 through the satellite channel. Due to this operation, the monitoring unit 301 can also identify the state of the satellite channel via the satellite communication terminal 31. It is possible that the monitoring-information setting request is either transmitted from the management device 15 through the satellite channel to the satellite communication terminal 31, or transmitted from the management device 15 through the wired path to the satellite communication terminal 31. For example, it is possible that the initial values of the monitoring-information processing policy information, that is, the monitoring-information processing policy information corresponding to the state in which no fault has occurred on the wired line 14, is registered by using a monitoring-information setting request. For example, the monitoring-information setting request for registration of the initial values of the monitoring-information processing policy information, is transmitted from the management device 15 through the wired bath to the satellite communication terminal 31. As described above, it is possible to register, change, and delete the transfer information on the basis of a command received from the management device 15 through the wired I/F unit 200 or the wireless I/F unit 202, that is, on the basis of the monitoring-information setting request.

FIG. 17 is a sequence diagram illustrating an example of the monitoring-information collecting process in the management device when a disaster has occurred in the present embodiment. FIG. 17 illustrates the process to be performed after the monitoring-information processing policy information in FIG. 16 has been changed. Due to a disaster, a fault has occurred in the relay station 16 that connects the mobile base stations 10a and 10b with the core network device 13 (Step S71). In FIG. 17, “the occurrence of a fault in the relay station 16” is described below “the core network device 13”. The fault in the relay station 16 does not refer to a fault in the core network device 13, but refers to a fault that occurs between the mobile base stations 10a and 10b, and the core network device 13. In this example, it is assumed that periodic monitoring-information transmission has been set in the mobile base stations 10a, 10b, and 10c. Due to a fault in the relay station 16, the monitoring unit 301 in the management device 15 fails to obtain monitoring information from the mobile base stations 10a and 10b, that is, does not receive the monitoring information for a given period of time or longer (Step S72). In this state, it is unclear whether the mobile base stations 10a and 10b are faulty, or the monitoring unit 301 fails to obtain monitoring information because of a disconnection of the communication path on the higher-level side than the mobile base stations 10a and 10b, that is, relatively closer to the management device 15.

Therefore, the monitoring unit 301 in the management device 15 calculates a divided-transfer time on the basis of the number of communication infrastructure devices from which the management device 15 is incapable of obtaining monitoring information (Step S73). It is also possible that the relation between the number of communication infrastructure devices and the divided-transfer time is stored as a table in the storage device 304 of the management device 15, and then the monitoring unit 301 references the table to derive a divided-transfer time corresponding to the number of communication infrastructure devices from which the management device 15 is incapable of obtaining monitoring information. It is further possible that the processing time per communication infrastructure device is defined in order to set the total processing time for the number of communication infrastructure devices, from which the management device 15 is incapable of obtaining monitoring information, as a divided-transfer time. The monitoring unit 301 in the management device 15, which has calculated the divided-transfer time, transmits a monitoring-information setting request by using the satellite channel (Step S74). The satellite communication terminals 31a, 31b, and 31c update the monitoring-information processing policy information in the storage device 207 on the basis of the monitoring-information setting request (Step S75). For example, it is assumed that this monitoring-information setting request is intended to instruct the settings for obtaining only the monitoring information including fault information from the mobile base stations 10a and 10b in the event of a disaster, that is, the settings for transferring only the monitoring information including fault information. Therefore, upon receiving monitoring information, other than the monitoring information including fault information, the satellite communication terminals 31a, 31b, and 31c perform a monitoring-information processing policy determination, and discard this received monitoring information (Step S76). The monitoring information including fault information for example, an SNMP packet with a specific value stored in “Specific Trap Type”, as illustrated in the processing number 6 in FIG. 7 and FIG. 16.

The mobile base station 10c that continuously communicates with the core network device 13 performs a monitoring-information processing policy determination on the periodically-received monitoring information, and continuously discards this monitoring information on the basis of the processing details (Step S76). The periodically-received monitoring information is supposed to be monitoring information corresponding to the processing number 4 in FIG. 7 and FIG. 16 similarly to the example in FIG. 15. Meanwhile, the mobile base stations 10a and 10b transmit the monitoring information including fault information due to a communication disconnection in the relay station 16. When the satellite communication terminals 31a and 31b receive monitoring information, other than the monitoring information including fault information, the monitoring-information processing unit 201 in the satellite communication terminals 31a and 31b performs a monitoring-information processing policy determination. When the monitoring-information processing unit 201 determines that the received monitoring information corresponds to the processing number 6, the unit 201 calculates a transfer delay time, starts the timer, and after the expiry of the timer, transmits a notification of a change in the monitoring information to the management device 15 via satellite channel (Step S77). Due to this operation, the management device 15 can update the device state of the mobile base stations 12a and 12b which are downstream of a faulty relay station 16. As described above, according to the sequence processing procedure in FIG. 17, the management device 15 an obtain monitoring information via the satellite channel from a communication infrastructure device, from which the management device 15 is incapable of obtaining monitoring information through the wired path due to a fault in the relay station 16 or the like. Further, the management device 15 is capable of efficiently collecting monitoring information by minimizing the usage of the satellite channel for a communication infrastructure device, from which the management device 15 does not need to obtain monitoring information. In the example in FIG. 17, monitoring information collection from a communication infrastructure device, from which the management device 15 does not need to obtain monitoring information, is completely stopped. However, it is also possible that the traffic reduction is employed by means of reducing the transmission frequency, that is, transferring monitoring information at a predetermined transfer rate.

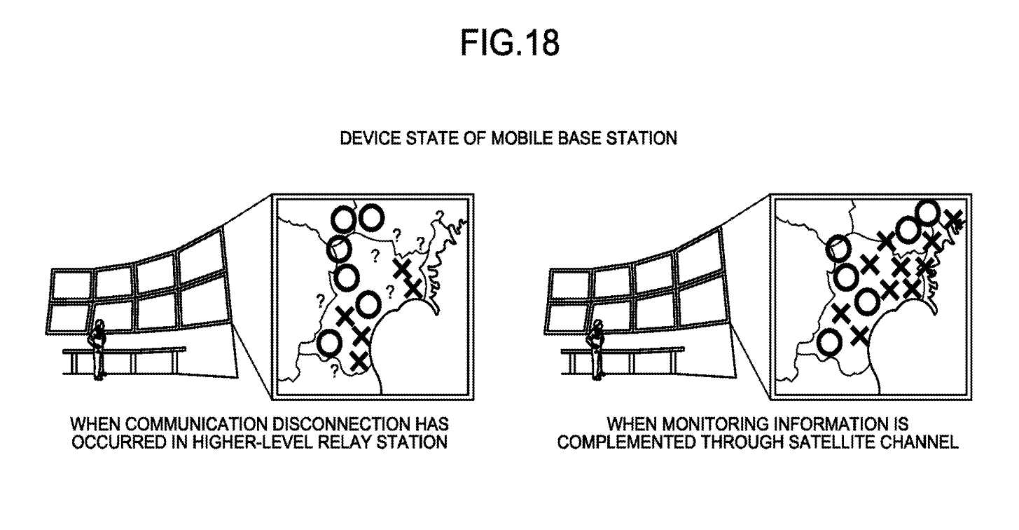

FIG. 18 is a diagram illustrating the device state of the mobile base station 10 managed by the management device 15 in the present embodiment, that is, a change in the device state of the mobile base station 10, which is indicated by the device-state information stored in the storage device 304. The left-side diagram in FIG. 18 illustrates the device state of the mobile base station 10 when only a wired path is used in the event of a communication disconnection in a relay station on the wired path due to a disaster or the like. The right-side diagram in FIG. 18 illustrates the device state of the mobile base station 10 when both a wired path and a satellite channel are used in the monitoring system according to the present embodiment in the event of a communication disconnection in a relay station on the wired path due to a disaster or the like. In FIG. 18, the mobile base station 10 that operates properly, from which the management device 15 is capable of obtaining monitoring information, is illustrated by a circle, while the mobile base station 10 that operates improperly, from which the management device 15 is still capable of obtaining monitoring information, is illustrated by a cross, and the mobile base station 10, from which the management device 15 is incapable of obtaining monitoring information, is illustrated by a question mark. The left-side diagram in FIG. 18 illustrates a state in which the management device 15 cannot obtain monitoring information from a plurality of mobile base stations 10. As illustrated in the right-side diagram in FIG. 18, in the present embodiment, the management device 15 complements monitoring information through the satellite channel, and therefore can identify the device state of the mobile base station 10.

As described above, according to the present embodiment, a monitoring-information processing unit that determines the monitoring information processing is provided in the satellite communication terminal 31, so as to limit the monitoring information to be transferred through the satellite channel by using the monitoring-information processing policy information. Therefore, even at the time of a major disaster, the communication system can efficiently collect the device state of the communication infrastructure devices in the ground radio communication system. Also, the communication system can monitor the ground radio communication system by using satellite communication with high reliability, while minimizing heavy communication traffic and congestion of the satellite channel.

The configurations described in the above embodiment are only examples of the content of the present invention. The configurations can be combined with other well-known techniques, and a part of each configuration can be omitted or modified without departing from the scope of the present invention.

### REFERENCE SIGNS LIST

10, 10a, 10b, 10c mobile base station, 11a, 11b, 11c, 21 service area, 12a, 12b, 12c mobile radio signal, core network device, 14 wired line, 15 management device, 20 satellite, 22a, 22b satellite radio signal, 23 satellite base station, 30a, 30c mobile device, 31, 31a, 31b, 31c satellite communication terminal, 100, 200, 300, 500 wired I/F unit, 101, 501 device management unit, 102, 202, 502 wireless I/F unit, 103, 203, 503 radio control unit, 104, 205, 303, 504 power unit, 105, 207, 304, 505 storage device, 106, 208, 506 antenna unit, 201 monitoring-information processing unit, 206 battery unit, 301 monitoring unit, 302 display unit, 305 input unit.

1. A satellite communication device comprising:
a first communication unit to receive monitoring information from a communication device, which is a result of monitoring a device state of the communication device;
a second communication unit to perform radio communication with a satellite;
a storage device to store therein transfer information that indicates conditions for selecting the monitoring information to be transferred to the second communication unit from among the monitoring information; and
a processing unit to select the monitoring information to be transferred to the second communication unit from among the monitoring information on a basis of the transfer information, and to transfer the selected monitoring information to the second communication unit.

2. The satellite communication device according to claim 1, wherein
the first communication unit communicates with a management device that monitors a device state of a device,
the second communication unit communicates with the management device through the satellite, and
it is possible to register, change, and delete the transfer information on a basis of a command received from the management device through the first communication unit or the second communication unit.

3. The satellite communication device according to claim 1, wherein
the transfer information includes conditions for selecting the monitoring information, and information that indicates processing details corresponding to the conditions, and
the information that indicates the processing details includes information that indicates whether to transfer or discard the monitoring information that satisfies the corresponding conditions.

4. The satellite communication device according to claim 3, wherein
the information that indicates the processing details includes information that indicates a process of transferring the monitoring information that satisfies the corresponding conditions with a delay, and
a delay time that is a time for delaying transfer in the process of transferring the monitoring information with a delay is calculated so as to differ between satellite communication devices.

5. The satellite communication device according to claim 1, wherein the communication device is a base station that constitutes a ground radio communication system.

6. A management device comprising:
a communication unit to receive monitoring information from a communication device, which is a result of monitoring a device state of the communication device through a wired line, and to update device-state information that indicates a device state of the communication device on a basis of the monitoring information;
a storage device to store therein the device-state information; and
a monitoring unit to generate control information for configuring settings for a satellite communication device being connected to the communication device, such that the monitoring information is transmitted to the management device itself through a satellite channel via the satellite communication device, when the management device cannot receive the monitoring information for a given period of time or longer, wherein
the communication unit transmits the control information to the satellite communication device, and
the monitoring unit updates the device-state information on a basis of the monitoring information received through the satellite communication device and a satellite channel.

7. The management device according to claim 6, wherein the monitoring unit performs alive confirmation on the satellite communication device on a basis of whether the management device can receive data from the satellite communication device through a satellite channel.

8. A monitoring system comprising:
a satellite communication device including:
a first communication unit to receive monitoring information from a communication device, which is a result of monitoring a device state of the communication device;
a second communication unit to perform radio communication with a satellite;
a storage device to store therein transfer information that indicates conditions for selecting the monitoring information to be transferred to the second communication unit from among the monitoring information; and
a processing unit to select the monitoring information to be transferred to the second communication unit from among the monitoring information on a basis of the transfer information, and to transfer the selected monitoring information to the second communication unit; and
the management device according to claim 6.

9. (canceled)
